(19) United States
(12) Patent Application Publication
(10) Pub. No.: US 2026/0289449 A1
(43) Pub. Date: Sep. 24, 2026

(54) SYSTEM

(71) Applicant: SoftBank Group Corp., Tokyo (JP)

(72) Inventor: Masato TAKAHASHI, Tokyo (JP)

(73) Assignee: SoftBank Group Corp., Tokyo (JP)

(21) Appl. No.: 19/567,477

(22) Filed: Mar. 16, 2026

(30) Foreign Application Priority Data
Mar. 19, 2025 (JP) 2025-045265

(51) Int. Cl. G06Q 10/0631; G06N 3/0475; G06Q 30/0201

(52) U.S. Cl. CPC G06Q 10/063119; G06N 3/0475; G06Q 30/0201

(57) ABSTRACT

A system includes a processor that is configured to collect information for attracting visitors to a facility from at least one sensor or at least one database and analyze the collected information by using a machine learning algorithm, acquire attributes of visitors by using at least one camera or at least one RFID sensor and analyze the acquired attributes by using a data mining technique, and generate, by using a natural language processing technique, a prompt sentence for instructing a generative artificial intelligence model to generate event content and input the prompt sentence to the generative artificial intelligence model.

### CROSS-REFERENCE TO RELATED APPLICATION

This application is based on and claims priority under 35 USC 119 from Japanese Patent Application No. 2025-045265 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional facility attraction systems generally rely on manual planning and static rules to design events and marketing activities. In many cases, information related to attracting visitors to a facility, such as foot traffic, purchasing behavior, and environmental conditions, is collected in a fragmented manner from sensors or databases, and is not effectively analyzed by machine learning. As a result, it is difficult for an operator to accurately understand visitor trends and optimize attraction strategies in real time. Furthermore, attributes of visitors, such as age group, gender, and visit frequency, are often not automatically obtained or are analyzed only superficially, which leads to event content that does not adequately match the interests and preferences of actual visitors. In addition, event creation commonly depends on human intuition and experience, and there is no systematic mechanism for automatically generating specific and appropriate event content based on comprehensive analysis of visitor data. Consequently, it is challenging to continuously provide attractive events while reducing the workload on operators and achieving effective attraction to the facility.

The invention has been made in view of the above circumstances, and an object of the invention is to provide a system capable of automatically collecting and analyzing information for attracting visitors to a facility from sensors and databases by using a machine learning algorithm, acquiring and analyzing visitor attributes by using cameras and RFID sensors with data mining techniques, and generating, by natural language processing, prompt sentences to be input to a generative artificial intelligence model so as to automatically produce event content that is suitable for the analyzed visitor trends and attributes. Another object of the invention is to reduce manual work in event planning and to enable an operator to quickly obtain high-quality event proposals that are expected to improve facility attraction.

### SUMMARY

In order to solve the above-described problems, according to one aspect of the invention, there is provided a system comprising a processor, wherein the processor is configured to collect information for attracting visitors to a facility from at least one sensor or at least one database and analyze the collected information by using a machine learning algorithm, acquire attributes of visitors by using at least one camera or at least one RFID sensor and analyze the acquired attributes by using a data mining technique, and generate, by using a natural language processing technique, a prompt sentence for instructing a generative artificial intelligence model to generate event content and input the prompt sentence to the generative artificial intelligence model.

In the system, the processor collects, as the information for attracting visitors, at least one of a number of visitors per time zone, stay time, purchasing history, environmental conditions, and operational status from the sensor or the database, and performs analysis such as pattern extraction, clustering, or prediction of visitor flow by the machine learning algorithm. The processor further acquires, as the attributes of the visitors, at least one of age group, gender, visit frequency, and movement pattern by using the camera or the RFID sensor, and performs analysis of attribute tendencies by the data mining technique. On the basis of a result of the analysis of the facility attraction information and the visitor attributes, the processor constructs a prompt sentence including at least one of a target age group, a target gender, a preferred time period, a desired event type, and an expected effect, by using the natural language processing technique, and inputs the constructed prompt sentence to the generative artificial intelligence model. The generative artificial intelligence model generates event content, such as an event title, event description, and proposed program, in response to the prompt sentence, thereby enabling automatic creation of event content that is appropriate for the analyzed visitor trends and attributes.

The term “system” refers to an arrangement of one or more hardware devices and software components that cooperate to perform the processing described in the claims, including at least a processor and any associated memory, interfaces, and peripheral devices. The term “processor” refers to any hardware component or combination of components that executes instructions, including but not limited to a central processing unit (CPU), a microprocessor, a digital signal processor (DSP), a graphics processing unit (GPU), or a programmable logic device, and may be implemented by a single device or a plurality of devices operating together.

The term “information for attracting visitors to a facility” refers to any data related to promotion, operation, or analysis of visitor behavior in or around a facility, including, for example, visitor counts, visitor flow, stay time, sales information, environmental conditions, marketing campaign data, and historical operation records.

The term “sensor” refers to any hardware device that detects or measures a physical, environmental, or behavioral parameter and outputs corresponding data, including but not limited to cameras, RFID readers, motion sensors, infrared sensors, people-counting sensors, and environmental sensors such as temperature or humidity sensors.

The term “database” refers to any structured or semi-structured data storage system in which information is recorded and from which information can be retrieved, including relational databases, non-relational databases, data warehouses, and log storage systems. The term “machine learning algorithm” refers to any algorithm or model that is capable of learning patterns or relationships from data and performing tasks such as classification, regression, clustering, prediction, or anomaly detection, including but not limited to neural networks, decision trees, random forests, support vector machines, and k-means clustering. The term “attribute of a visitor” refers to any characteristic or profile element associated with an individual visitor, including, for example, age group, gender, visit frequency, movement pattern, purchase behavior, membership status, or other demographic or behavioral information.

The term “camera” refers to an image capturing device that obtains still images or video images of at least a part of the facility or its surroundings, including digital cameras, network cameras, and surveillance cameras capable of outputting image data for analysis.

The term “RFID sensor” refers to a device including an RFID reader that communicates with RFID tags carried by visitors or attached to objects, and that acquires identification information, location information, or movement information based on radio frequency communication.

The term “data mining technique” refers to any analytical method or process for discovering patterns, correlations, trends, or rules from large datasets, including, for example, clustering, association rule mining, sequence pattern mining, and statistical analysis.

The term “natural language processing technique” refers to any technique or algorithm that processes, analyzes, or generates human language in text or voice form, including but not limited to tokenization, part-of-speech tagging, semantic analysis, language modeling, and natural language generation.

The term “prompt sentence” refers to a text string or structured natural language expression that is provided as an input to a generative artificial intelligence model in order to specify conditions, constraints, or instructions for generating event content.

The term “generative artificial intelligence model” refers to an artificial intelligence model that produces new content in response to input data, including but not limited to a generative language model or multimodal model capable of generating text, such as event titles, descriptions, and program details, based on a prompt sentence.

The term “event content” refers to information describing an event to be conducted at or in connection with the facility, including at least one of an event title, event description, schedule, target audience, program details, promotional messages, and operational instructions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

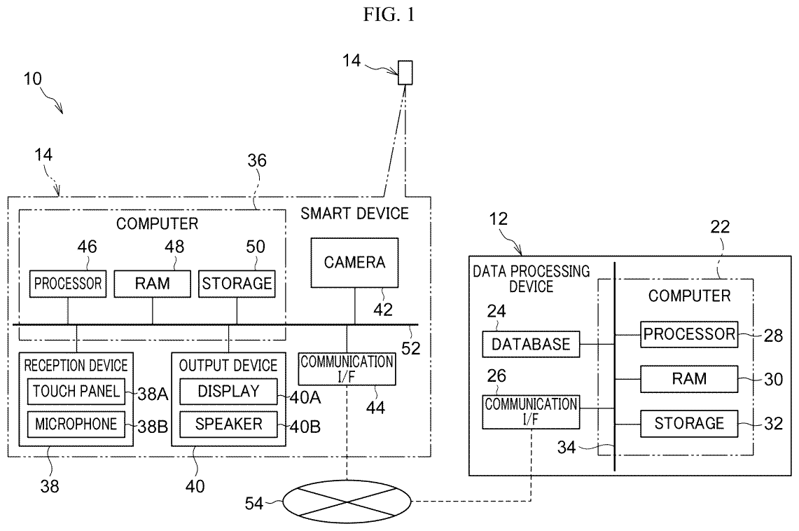

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

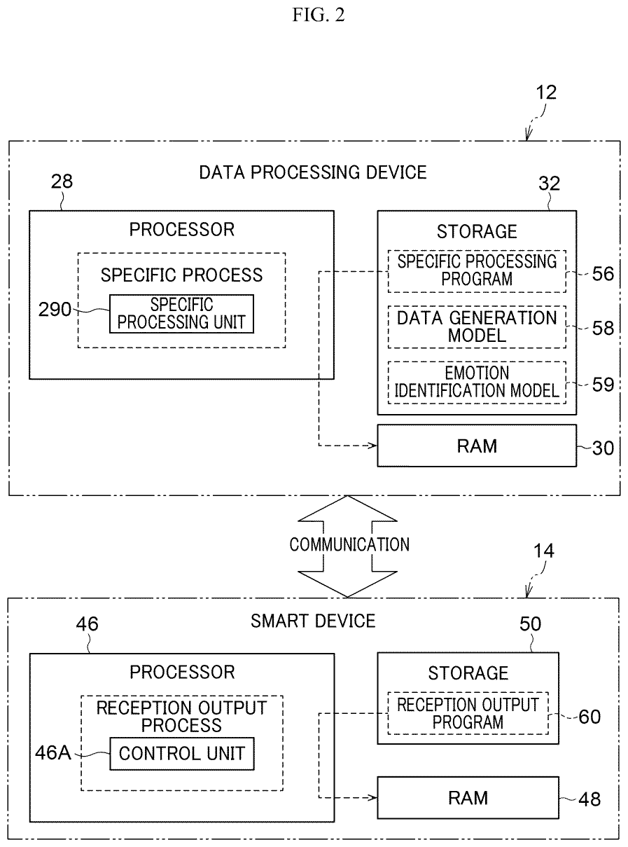

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for planning events and allocating workers in facilities such as commercial venues, entertainment venues, or public spaces typically rely on fixed business rules, static reports, and manual analysis of visitor logs. In such systems, visitor information obtained from heterogeneous detection devices and information storage devices is often stored in isolated data silos without being integrated into coherent visit session information. As a result, existing systems are unable to automatically derive high-quality feature data that accurately reflects visitor segments, attraction peak times, and behavioral tendencies over time.

Furthermore, in many existing solutions, machine learning components, if present at all, are loosely coupled and operate only on limited subsets of data. These components do not perform end-to-end processing from raw detection signals through preprocessed feature generation to model-based forecasting and optimization. Consequently, the systems cannot efficiently compute accurate forecasts of visitor volumes or event participation probabilities, nor can they automatically determine worker allocation plans that optimize operational resources while maintaining a desired service level.

In addition, even when generative artificial intelligence models are used to propose event contents, conventional systems typically rely on manually crafted prompt sentences that are not systematically grounded in the actual analytical context of the facility. The prompt sentences often omit essential structured information such as visitor segments, forecasted peak times, or existing worker constraints. This results in generated outputs that are difficult to operationalize, inconsistent in quality, and not closely aligned with current facility conditions. The need for human operators to repeatedly translate analytical data into natural language prompts introduces inefficiency and a risk of errors.

Accordingly, there is a need for an improved computer-implemented system that integrates the entire processing pipeline on a processor: acquisition and integration of heterogeneous visit information into visit session information; automated preprocessing to generate analysis feature data; execution of learning-model processes to derive segment information, peak-time information, and event-participation probability information; generation of event-plan information and allocation-plan information based on these analytical outputs; and automatic construction of context-rich prompt sentences for generative artificial intelligence models. Such a system should reliably transform raw sensor-level data into optimized event planning and worker allocation, reduce the dependency on manual rule creation and ad hoc prompt authoring, and thereby improve the functioning of the underlying computer system in terms of data utilization, processing efficiency, and quality of decision support.

The specific processing by the specific processing unit 290 of the data processing device 12 in Example 1 is realized by the following means.

The present invention provides a server comprising a processor configured to acquire visit information in a facility from detection devices and information storage devices, and integrate a plurality of types of visit information including a number of visitors, visit times, visitor attributes, and behavior histories, and store the integrated information as visit session information; perform preprocessing on the visit session information, the preprocessing including missing-value completion, normalization, attribute encoding, and feature extraction of time information, and generate analysis feature data; execute a learning-model process on the analysis feature data, the learning-model process including classification processing, clustering processing, and time-series prediction processing, and obtain segment information of visitor groups, peak-time information of visitor attraction, and event-participation probability information; generate event-plan information and allocation-plan information based on the segment information and the peak-time information, the event-plan information including an event type, a target visitor group, a holding time period, a required number of workers, and required worker roles, and the allocation-plan information including a worker allocation plan corresponding to predicted demand; extract context information from the event-plan information and the allocation-plan information as a part of an input sentence for language generation, combine the context information with a request sentence in natural language that a user has input from a terminal, and generate a prompt sentence to be input to a generative AI model; transmit the prompt sentence to the generative AI model, and acquire, from the generative AI model, generated-result information including event contents, execution procedures, notification texts, and worker allocation proposals; and update the event-plan information and the allocation-plan information based on the generated-result information, and store and output the updated information as an updated event plan and an updated worker allocation plan. This enables an end-to-end improvement of computer functionality in which heterogeneous sensor-level and database-level visitor data are automatically transformed, through integrated analytical and optimization processes and context-aware prompt generation for a generative AI model, into operationally usable and dynamically updated event and worker allocation plans, thereby reducing manual intervention, improving processing efficiency, and enhancing the quality and reliability of computer-generated operational decisions.

The term “visit information” refers to data that represents one or more aspects of a visitor's presence in a facility, including but not limited to a number of visitors, visit times, visitor attributes, and behavior histories acquired from detection devices and information storage devices.

The term “detection device” refers to any hardware device configured to detect a visitor or a visitor-related event in a facility, including but not limited to a sensor, a camera, a reader, or a terminal that generates detection signals or measurement data.

The term “information storage device” refers to any hardware or software component configured to store data related to visitors or facility operations, including but not limited to a database system, a file system, or a memory device.

The term “visit session information” refers to integrated data that associates multiple pieces of visit information with an individual visitor or a group of visitors over a defined time period, and that is stored as a unified record or set of records.

The term “preprocessing” refers to a series of computational operations performed on raw or integrated data before analysis, including but not limited to missing-value completion, normalization, attribute encoding, and feature extraction of time information.

The term “missing-value completion” refers to a process of detecting absent or undefined data elements in visit session information and replacing them with imputed or default values according to predetermined rules or algorithms.

The term “normalization” refers to a process of transforming numerical data into a standardized scale or range, such as scaling values or adjusting distributions, to improve comparability and stability for subsequent analysis or learning processes.

The term “attribute encoding” refers to a process of converting categorical or symbolic visitor attributes into numerical or structured representations suitable for computational processing by learning models.

The term “feature extraction of time information” refers to a process of converting raw time-related data, such as timestamps, into derived features, such as hour of day, day of week, or periodic patterns, for use in analytical or predictive processing.

The term “analysis feature data” refers to data obtained after preprocessing visit session information, the data being structured and formatted as input for learning-model processes, including numerical and encoded features.

The term “learning-model process” refers to a computational procedure that applies one or more learning algorithms to analysis feature data in order to discover patterns, make predictions, or infer relationships, and that may include training and inference operations. The term “classification processing” refers to a type of learning-model process that assigns input data to one or more predefined categories or labels based on learned decision boundaries or probability distributions.

The term “clustering processing” refers to a type of learning-model process that groups input data into clusters such that data in the same cluster is more similar to each other than to data in other clusters, without requiring predefined labels.

The term “time-series prediction processing” refers to a type of learning-model process that analyzes sequential data over time and predicts future values or trends based on historical patterns.

The term “segment information” refers to information indicating a categorization or grouping of visitors into segments or clusters based on visitor attributes, behaviors, or other features. The term “visitor group” refers to a set of visitors that share one or more common characteristics, such as demographic attributes, behavioral patterns, or visit frequencies, and that may correspond to a segment identified by a learning-model process.

The term “peak-time information” refers to information indicating time periods in which visitor attraction or facility usage is expected or observed to be relatively high, based on analysis of visit information or time-series prediction processing.

The term “event-participation probability information” refers to information indicating a likelihood that a visitor or a visitor group will participate in a particular event or type of event, as estimated by a learning-model process.

The term “event-plan information” refers to structured data representing a plan for an event to be held in a facility, including at least an event type, a target visitor group, a holding time period, a required number of workers, and required worker roles.

The term “event type” refers to a classification or category of an event, such as a promotional event, a performance, a workshop, or another type of activity conducted in a facility. The term “target visitor group” refers to a visitor group for which a particular event is primarily planned or intended, as indicated in event-plan information.

The term “holding time period” refers to a time interval during which an event is scheduled to occur or is planned to be conducted in a facility.

The term “required number of workers” refers to a quantity of workers that are planned or determined to be necessary to execute an event or support facility operations during a specified time period.

The term “required worker role” refers to a functional responsibility or position assigned to a worker, such as reception, guidance, security, or operation of equipment, as defined in event-plan information or allocation-plan information.

The term “allocation-plan information” refers to structured data representing a plan for assigning workers to tasks, locations, or time periods in a facility, and may include a worker allocation plan corresponding to predicted demand.

The term “worker allocation plan” refers to a specification of how workers are to be distributed or scheduled across times, areas, or roles in a facility, based on analytical or optimization processing.

The term “context information” refers to information derived from event-plan information, allocation-plan information, or analytical results that provides background, constraints, or parameters for generating an input sentence to a generative AI model.

The term “request sentence” refers to a natural-language sentence or text input by a user through a terminal, the sentence expressing a request or instruction regarding event planning, worker allocation, or related operations.

The term “prompt sentence” refers to an input sentence or text provided to a generative AI model, the sentence being constructed by combining context information and a request sentence, and used to condition or guide the generation of output.

The term “generative AI model” refers to a computational model, such as a generative language model, configured to generate text or other content in response to an input prompt sentence, based on learned patterns from training data.

The term “generated-result information” refers to information output by a generative AI model in response to a prompt sentence, the information including at least event contents, execution procedures, notification texts, or worker allocation proposals.

The term “event contents” refers to descriptive information about an event, including a theme, activities, schedule details, and other elements that define what is to be provided to visitors.

The term “execution procedures” refers to stepwise or structured instructions for implementing an event or operational plan, including preparation steps, execution steps, and post-event steps.

The term “notification text” refers to a text string suitable for communication to visitors or workers, such as an announcement, an advertisement message, or an internal notice related to events or operations.

The term “worker allocation proposal” refers to a suggested plan generated by a generative AI model for distributing workers among roles, locations, or times in a facility.

The term “updated event plan” refers to event-plan information that has been modified based on generated-result information from a generative AI model and stored as a revised event planning record.

The term “updated worker allocation plan” refers to allocation-plan information that has been modified based on generated-result information from a generative AI model and stored as a revised worker allocation record.

The term “structured context information” refers to context information that is formatted or organized according to a predefined structure, such as a list, a template, or a schema, and is suitable for systematic combination with a request sentence.

The term “summary information” refers to information that represents a condensed or aggregated form of underlying data, such as visit session information or analysis feature data, highlighting key metrics, patterns, or statistics.

The term “optimization process” refers to a computational process that selects values for decision variables, such as worker allocations, subject to one or more constraints, in order to minimize or maximize an objective function, such as cost or service level.

The term “constraint condition” refers to a limitation or requirement that must be satisfied by the solution of an optimization process, such as a maximum number of workers, working-hour limits, or minimum service-level requirements.

The term “service level” refers to a quantitative or qualitative measure of performance in serving visitors, such as waiting time, response time, or coverage of staff in a facility, used as a criterion in optimization or evaluation.

In one embodiment, a server implements the claimed system as a network-connected computer system including at least one processor, a main memory, a non-volatile storage device, and a network interface. The server executes an operating system such as a general-purpose server operating system and runs application programs implemented, for example, in a programming language such as Python or Java. The server communicates with one or more terminals via a communication network such as a local area network or a wide area network using a protocol such as HTTP or HTTPS. The server also communicates with detection devices and information storage devices deployed in a facility.

The server uses detection devices such as cameras, radio-frequency readers, infrared sensors, and wireless beacons to acquire visit information. The server receives signals including time-stamped detection events from these devices through a message queue or a streaming platform. The server also accesses information storage devices such as relational database systems and file systems to retrieve historical logs and profile information. The server stores the acquired raw visit information into a structured database, for example a relational database, by inserting records into tables such as a visit log table and a visitor profile table. Each record in the visit log table may include fields such as a visitor identifier, a device identifier, a detection timestamp, a location identifier, and a detection type. Each record in the visitor profile table may include fields such as age group, gender, membership type, and interest tags.

The server generates visit session information by integrating multiple records from different tables corresponding to a continuous presence of a visitor in the facility. The server performs a data integration process implemented, for example, using a data-processing framework such as a data analysis library and a workflow scheduler. The server groups visit log records by visitor identifier and sorts them by timestamp. The server identifies session boundaries by applying rules such as a maximum allowable gap between detection timestamps. When the gap between two consecutive detections exceeds a predetermined threshold, the server terminates the current session and starts a new session. The server calculates session-level attributes such as session start time, session end time, stay duration, number of areas visited, and total number of detection events. The server joins session-level records with profile records using the visitor identifier and stores the resulting visit session information in a session table. This explicit sessionization improves the consistency and granularity of the data structure and enables learning models to operate on well-defined sequences rather than on isolated events, which improves prediction accuracy and computational efficiency. The server performs preprocessing on the visit session information to generate analysis feature data. The server loads session records into memory using a data analysis library such as a tabular-data processing library. The server executes missing-value completion by scanning each column of the session table and identifying null or invalid values. For numerical attributes such as stay duration or number of areas visited, the server fills missing values with statistically derived values such as median or mean per segment or per day. For categorical attributes such as age group, the server uses rules that prioritize membership data over sensor-estimated data, thereby reducing noise from unreliable estimates. For attributes that are completely missing and cannot be reliably inferred, the server assigns a special “unknown” category, which allows learning models to handle such cases without dropping the records.

The server normalizes numerical attributes to improve numerical stability and convergence of learning models. For example, the server converts raw timestamps into derived temporal features such as hour-of-day encoded as a value between 0 and 23, day-of-week encoded as an integer between 0 and 6, and whether the day is a holiday or a weekday encoded as a binary value. The server scales continuous values such as stay duration and total spending using a scaling method such as min-max scaling or z-score normalization. The server performs attribute encoding for categorical attributes by converting them into one-hot vectors or embedding indices. For example, the server converts age group categories into binary indicator columns, and converts interest tags into sparse binary vectors indicating the presence or absence of each tag in a predefined vocabulary. The server stores the resulting analysis feature data in a feature table or in serialized files. The use of structured feature representations reduces the dimensionality and redundancy of the data and improves cache locality and memory access patterns in subsequent learning-model processes, thereby improving processing speed and energy efficiency.

The server executes learning-model processes on the analysis feature data to obtain segment information, peak-time information, and event-participation probability information. In one embodiment, the server implements a clustering model to derive visitor segments. The server uses an algorithm such as k-means clustering, where the server initializes cluster centroids in the multi-dimensional feature space, iteratively assigns each visitor session to the nearest centroid using a distance metric such as Euclidean distance, and updates the centroids based on the assigned sessions. The server stores the final cluster identifiers as segment labels in association with each session record. Because the server operates on pre-normalized and encoded features, the clustering converges more quickly and yields higher-quality clusters than when using raw unprocessed data.

In another embodiment, the server implements a supervised learning model to estimate event-participation probabilities. The server uses historical event-attendance information, where each session is labeled with whether the visitor participated in a particular class of event. The server constructs a training dataset comprising input feature vectors and binary labels. The server configures a neural network model, for example a multilayer perceptron with one or more hidden layers. Each hidden layer may include a specified number of neurons, such as 64 or 128 neurons per layer, with a non-linear activation function such as a rectified linear unit. The server defines an output layer with a sigmoid activation function to output a probability between 0 and 1 indicating the likelihood of participation. The server defines a loss function such as binary cross-entropy and uses an optimization algorithm such as stochastic gradient descent or Adam. During training, the server repeatedly performs forward propagation to compute outputs and loss, and backpropagation to compute gradients with respect to the weights. The server updates the weights in the direction that reduces the loss. The server may also perform data augmentation, such as randomly perturbing time features within a small tolerance or masking some categorical attributes, to improve generalization. After training, the server uses the trained neural network to infer event-participation probabilities for new sessions. This model-based probability estimation allows the system to prioritize events that are more likely to attract specific visitor segments, thus improving operational outcomes.

The server also implements a time-series prediction model to derive peak-time information. The server aggregates visitor counts per time interval, such as every 15 minutes, and constructs a time series for each facility area or for the entire facility. The server applies a recurrent neural network architecture such as a long short-term memory network. The input to the network is a sequence of past counts and corresponding temporal features (for example, hour-of-day, day-of-week, holiday indicator). The network includes one or more recurrent layers, each with a specified number of units, and optionally a fully connected output layer. The server defines a loss function such as mean squared error between predicted and actual counts. During training, the server performs sequential forward passes through the network to obtain predictions, computes the loss, and uses backpropagation through time to update the weights. The server stores the trained weights in a model repository. During operation, the server inputs the latest sequence of counts and temporal features to the trained network to obtain predicted counts for future time intervals. Because the server explicitly models temporal dependencies and periodicity through the recurrent architecture, the prediction error is reduced compared to rule-based or linear models, which improves the accuracy of peak-time detection and leads to more efficient resource allocation. The server generates event-plan information using the outputs of the learning-model processes. The server determines one or more target visitor segments by selecting segment identifiers that have high event-participation probabilities for specific event types. The server maps each segment to candidate event types stored in a template repository. For example, the server may select a music performance template for segments characterized by younger age groups and high interest in entertainment, and select a workshop template for segments characterized by families. The server then combines the predicted peak-time information with the event templates to assign holding time periods that are temporally aligned with expected visitor concentrations for the target segments. The server calculates a required number of workers and required worker roles by applying rules that consider predicted counts, facility safety constraints, and service-level targets. For example, the server may compute the number of reception workers, guidance workers, and security workers as piecewise linear functions of predicted visitor counts. The server writes the resulting event-plan information into a plan table.

The server generates allocation-plan information by performing an optimization process that uses peak-time information and event-participation probability information as inputs. The server defines decision variables representing the number of workers assigned to each role and time interval. The server imposes constraint conditions such as maximum working hours per worker, minimum number of workers per role, and total labor cost budget. The server defines an objective function that minimizes total cost subject to a penalty term for under-coverage of service level. The server may use a linear or integer programming solver to compute an optimal or near-optimal assignment. The solver iteratively explores candidate solutions and updates the decision variables to improve the objective value while satisfying constraints. By formulating the allocation problem as a mathematical optimization and solving it algorithmically, the system achieves worker allocation patterns that are not easily derivable by manual methods, reduces over-allocation and under-allocation, and improves both cost efficiency and quality of service.

The terminal functions as a user interface device and may be implemented as a mobile information processing device or a personal computer running a web browser or a dedicated application. The terminal establishes a secure connection to the server and retrieves event-plan information, allocation-plan information, and analytical summaries. The terminal displays dashboards including charts of predicted visitor counts, lists of target segments, tables of event plans, and schedules of worker allocations. The terminal provides an input field in which the user can input a request sentence in natural language. The user can, for example, input prompt sentences such as:
“Create an event plan for women in their 20s for Saturday between 2 PM and 6 PM using the latest visitor data.”
“Suggest three low-cost weekday morning events to improve attendance among families with children under 10.”
“Based on the latest visitor data, suggest an event plan and promotional messages for Friday evening targeting office workers aged 30-40.”
“Adjust this event to fit within a budget of $5,000 and shorten it to 90 minutes.”

The terminal sends the user's request sentence to the server together with identifiers of the relevant event-plan information and allocation-plan information.

The server generates a prompt sentence for a generative AI model by combining structured context information and the user's request sentence. The server retrieves event-plan information and allocation-plan information for the relevant period and extracts context information such as target segments, predicted visitor counts, holding time periods, current worker allocation constraints, and key performance targets. The server encodes this context information into a structured textual description, for example a short paragraph summarizing the current operational scenario. The server then concatenates this structured context information with the user's request sentence to form a prompt sentence. The server may apply a non-trivial rule set for ordering and formatting the context elements to ensure that the generative model receives the most salient constraints first, thereby improving consistency and reducing variability in the generated results compared to naive concatenation. The server transmits the prompt sentence to a generative AI model via a model-serving interface. The generative AI model may be implemented on a separate computing system equipped with one or more processors and accelerators, and may be configured as a neural network-based language model with multiple layers of attention mechanisms. The server formats the request in a protocol such as a structured message containing a system role description, the context portion, and the user request portion. The generative AI model processes the input tokens, performs internal matrix multiplications and non-linear transformations using stored parameter weights, and outputs a sequence of tokens forming generated-result information. The generated-result information includes textual descriptions of event contents, detailed execution procedures, notification texts, and worker allocation proposals that conform to the operational constraints encoded in the prompt sentence. Because the server systematically injects machine-generated analytical results into the prompt sentence, the generative AI model produces outputs that are aligned with actual facility conditions, and the quality and relevance of the results are improved compared to prompts constructed manually.

The server updates event-plan information and allocation-plan information based on the generated-result information. The server parses the generated text, identifies structured elements such as event titles, time ranges, required roles, and messaging content, and maps these elements to corresponding fields in the internal data structures. The server modifies or creates records in the plan tables to reflect these elements and stores them as updated event plans and updated worker allocation plans. The server also logs the association between input prompt sentences and generated results. The server may then send the updated plans back to the terminal for display. The user can view the updated plans, provide additional request sentences to refine the results, and ultimately approve a selected plan for deployment. The server in this system improves computer technology in several ways beyond merely automating human planning tasks. First, the server employs specific data structures (session tables, feature tables, segment labels, and allocation variables) and non-conventional processing flows (sessionization, feature extraction, multi-model learning, and constrained optimization) that transform heterogeneous raw sensor data into optimized resource allocation outputs in a manner that reduces processing redundancy and improves memory access efficiency. Second, the server uses learning-model processes with explicitly defined architectures, loss functions, and weight-update methods, which reduce prediction errors for visitor counts and event participation relative to simpler rule-based or linear methods, resulting in fewer plan revisions and less communication overhead between systems. Third, the server integrates analytical outputs into prompt sentences for a generative AI model using structured context information and ordering rules, thereby producing more deterministic and reliable text outputs, which reduces post-processing corrections and improves throughput. In another embodiment, the server may use alternative learning algorithms, such as gradient boosting decision trees for event-participation probability estimation, or convolutional neural networks to capture temporal patterns in visitor flows. The server may also use different optimization methods, such as metaheuristic algorithms, to solve large-scale allocation problems when the number of workers and time intervals is very high. In yet another embodiment, the server may operate with different detection devices, such as environmental sensors that detect crowd density or noise levels, and incorporate these as additional features in the analysis feature data.

The terminal may be implemented as a kiosk located inside the facility, allowing facility managers or operators to interact with the system on-site. The user may use the terminal to adjust system parameters, such as acceptable service-level thresholds or maximum budget levels, and these parameters may be used by the server to recalculate allocation-plan information and regenerate prompt sentences. The generative AI model may be replaced or supplemented by other generative models, such as models that output structured data directly, instead of text, provided that such models accept prompt sentences or equivalent conditioning inputs.

Because the server defines explicit data flows, model architectures, optimization formulations, and prompt-construction rules, and couples them with real-world detection devices and allocation mechanisms, the system as a whole achieves technical effects such as increased prediction accuracy, reduced computational overhead through efficient preprocessing and feature engineering, reduced network traffic by transmitting structured summaries instead of raw logs, and improved stability of generative outputs through context-aware prompt management. These technical improvements arise from the particular configuration and interaction of the server, terminal, and learning models, and are not merely a computer implementation of an abstract business practice.

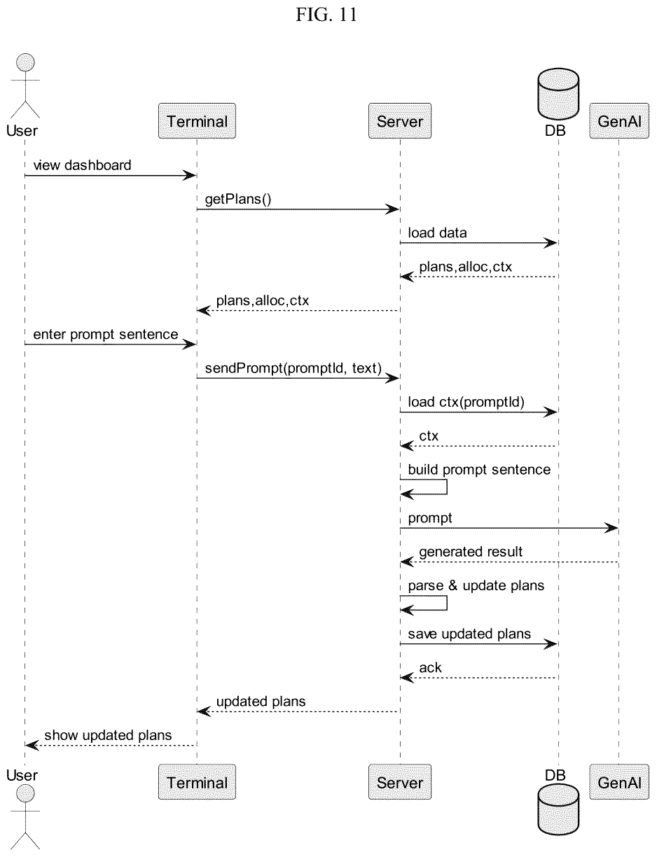

The following describes the processing flow using FIG. 11.

### Step 1:

Server acquires raw visit information from detection devices and information storage devices.

Server receives as input detection signals including timestamps, device identifiers, and preliminary visitor identifiers from cameras, radio-frequency readers, motion sensors, and wireless beacons, and historical logs and profile records from database systems. Server writes as output individual visit log records into a visit log table and individual profile records into a visitor profile table.

Server performs data parsing and validation on the incoming signals, converts device-specific formats into a unified schema (for example, standardized timestamp format and location codes), and discards records that do not satisfy minimal integrity checks (for example, missing timestamp or device identifier).

### Step 2:

Server generates visit session information by integrating raw visit log records. Server reads as input the visit log records and visitor profile records from the database. Server groups the visit log records by visitor identifier and sorts them in chronological order, computes time gaps between consecutive detections, and determines session boundaries when the time gap exceeds a predetermined threshold.

Server calculates as output session-level attributes such as session start time, session end time, stay duration, number of visited locations, and merges these with profile attributes such as age group and membership type to produce visit session information, which the server stores in a session table.

### Step 3:

Server performs missing-value completion on the visit session information.

Server takes as input the session table containing numeric attributes (for example, stay duration, number of locations) and categorical attributes (for example, age group, gender, interest tags) with possible nulls.

Server computes statistical measures such as mean, median, and mode per attribute and per segment (for example, per day-of-week) and applies rules that prioritize profile-derived values over sensor-derived estimates; server replaces missing numeric values with derived statistics and missing categorical values with either inferred categories or an “unknown” category.

Server outputs a cleaned session table where missing fields have been filled according to the defined rules, thereby producing a more complete dataset for subsequent modeling.

### Step 4:

Server performs normalization and time-feature extraction to generate analysis feature data.

Server uses as input the cleaned session table from Step 3.

Server converts absolute timestamps into derived time features such as hour-of-day, day-of-week, and holiday/weekday indicators, scales continuous attributes (for example, stay duration and total spending) using methods such as min-max scaling or z-score normalization, and encodes categorical attributes (for example, age group and interest tags) into numerical representations such as one-hot vectors or index-coded fields.

Server writes as output an analysis feature table in which each record is represented as a compact numerical feature vector suitable for input to learning models.

### Step 5:

Server performs clustering processing on the analysis feature data to derive segment information.

Server reads as input the analysis feature vectors from Step 4.

Server applies a clustering algorithm such as k-means: initializes a specified number of cluster centroids in the feature space, iteratively assigns each session vector to the nearest centroid based on a distance metric, and updates each centroid as the mean of the assigned vectors until convergence according to a stopping criterion.

Server outputs a cluster label for each session and stores these labels as segment information in association with the session records, thereby partitioning visitors into distinct behavioral or demographic groups.

### Step 6:

Server performs classification processing to estimate event-participation probability information.

Server accepts as input labeled feature data consisting of past session feature vectors and corresponding binary labels indicating participation or non-participation in one or more event types.

Server configures and trains a neural network classifier: defines network layers (input layer, one or more hidden layers with non-linear activation, and an output layer with a sigmoid activation), computes forward passes to generate predicted probabilities, computes a loss value using a loss function such as binary cross-entropy, and updates weight parameters using an optimization algorithm such as stochastic gradient descent or Adam, repeating this process over multiple epochs.

Server outputs for each session a probability value representing the likelihood of event participation and stores these probability values as event-participation probability information linked to the session and segment identifiers.

### Step 7:

Server performs time-series prediction processing to obtain peak-time information.

Server uses as input aggregated visitor counts per time interval (for example, every 15 minutes) and corresponding temporal features derived from the session data.

Server feeds sequences of past counts and temporal features into a time-series model such as a recurrent neural network with long short-term memory units; server computes predicted future counts through forward passes, calculates prediction error using a loss function such as mean squared error, and iteratively updates network weights by backpropagation through time until the prediction error is reduced below a threshold or training epochs are completed.

Server stores as output predicted visitor counts for future intervals and identifies time intervals whose predicted counts exceed a predefined threshold as peak-time information, which the server records in a peak-time table.

### Step 8:

Server generates event-plan information based on segment information, event-participation probability information, and peak-time information.

Server reads as input the segment labels, participation probabilities, and peak-time intervals from Steps 5 to 7 and retrieves predefined event templates from a template repository.

Server selects target segments that exhibit high participation probabilities for specific event templates, maps these templates to peak-time intervals that align with the availability of the target segments, and computes for each candidate event the holding time period, required number of workers, and required worker roles using rules that relate predicted visitor counts and event type characteristics to staffing needs.

Server outputs structured event-plan information records including event type, target visitor group, holding time period, required number of workers, and required worker roles, and stores these records in an event-plan table.

### Step 9:

Server generates allocation-plan information by executing an optimization process.

Server takes as input the event-plan information from Step 8, peak-time information from Step 7, and constraint parameters such as maximum available workers, working-hour limits, and target service levels.

Server formulates an optimization problem where decision variables represent the number of workers assigned to each role and time interval, defines an objective function that minimizes total labor cost with penalties for violating minimum service levels, and enforces constraint conditions related to worker availability, maximum hours, and regulatory limits; server then uses an optimization solver to iteratively adjust decision variables and evaluate the objective until a feasible near-optimal solution is found.

Server writes as output allocation-plan information including a worker allocation plan per time interval and role, and stores this information in an allocation-plan table.

### Step 10:

Server constructs structured context information for prompt generation.

Server reads as input the event-plan information and allocation-plan information for a specified planning horizon, along with summary statistics derived from segment information and peak-time information.

Server selects key attributes such as target segments, expected visitor counts, scheduled events, staffing constraints, and performance targets, and composes a concise, structured textual description that encodes these attributes in a fixed order and format, for example as enumerated sentences summarizing the operational situation.

Server outputs structured context information as a text block associated with a planning identifier and stores it in a context table, preparing it for combination with user-entered request sentences.

### Step 11:

Terminal presents the analysis results and accepts a user request sentence.

Terminal receives as input from the server the event-plan information, allocation-plan information, and structured context summaries corresponding to a selected date or time range. Terminal displays charts, tables, and textual summaries to the user and provides a text input field labeled, for example, “Enter prompt sentence for generative AI model.” User observes the displayed information and inputs as output a request sentence in natural language, such as “Create an event plan for women in their 20s for Saturday between 2 PM and 6 PM using the latest visitor data,” using a keyboard or touch interface; terminal transmits this request sentence and the selected context identifier to the server.

### Step 12:

Server generates a prompt sentence for a generative AI model.

Server accepts as input the user request sentence from the terminal and the corresponding structured context information from the context table.

Server applies predetermined rules to concatenate or merge the context text and the user request sentence, for example by placing the context as background constraints followed by the user request as an instruction, and may insert delimiters or labels to distinguish between constraint descriptions and user instructions.

Server outputs a single prompt sentence (or prompt text block) that combines both elements in a form suitable for the generative AI model and stores the prompt together with metadata such as timestamp and user identifier.

### Step 13:

Server invokes the generative AI model using the prompt sentence and receives generated-result information.

Server uses as input the prompt sentence constructed in Step 12 and, if required by the model interface, additional parameters such as maximum output length or temperature settings.

Server sends a request containing the prompt to the generative AI model through a network interface, receives tokenized text output from the model in response, and reconstructs the output into coherent text segments corresponding to event contents, execution procedures, notification texts, and worker allocation proposals.

Server outputs generated-result information as structured text sections and records these sections in a generated-results table linked to the originating prompt and user.

### Step 14:

Server updates event-plan information and allocation-plan information based on the generated-result information.

Server reads as input the generated-result information from Step 13 and the existing event-plan and allocation-plan records.

Server parses the generated text, extracts structured elements such as proposed event titles, adjusted time ranges, revised required worker counts, and suggested promotional messages, and maps these elements to corresponding fields in the internal data schema; server then modifies existing records or inserts new records to reflect the proposed changes, subject to consistency checks and constraint validations.

Server outputs updated event plans and updated worker allocation plans, stores them in the corresponding tables, and makes them available to the terminal for subsequent display or final approval by the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In commercial environments and other facilities that rely on visitor traffic, operators increasingly attempt to use digital systems to analyze visitor behavior and to plan events or promotions. Conventional systems typically focus on static reporting of historical visitor counts or simple rule-based recommendations. Such systems often treat data collection, analytics, content generation, and operator feedback as separate and loosely coupled processes. As a result, these systems suffer from several technical problems.

First, conventional architectures frequently require human operators to manually extract data from databases, perform ad hoc preprocessing in separate tools, and then manually prepare input for downstream machine learning engines or content generation engines. This fragmented pipeline increases processing latency, consumes computing resources inefficiently, and causes inconsistency between datasets used in different stages. The lack of an integrated preprocessing and feature-generation mechanism makes it difficult for the computer system to automatically learn and update fine-grained visit tendencies and participation tendencies.

Second, conventional machine learning modules, when present, are often trained only once or only on coarse-grained aggregate data, without systematic incorporation of real-time or near-real-time feedback such as actual participation results, sales results, or administrator approvals and modifications. Because such feedback is not persistently associated with the underlying time-series and attribute data, the prediction models cannot be retrained effectively. This leads to models that degrade over time, produce inaccurate predictions of visit counts and participation probabilities, and require frequent manual tuning by experts. Consequently, the computer system does not sufficiently improve its prediction performance based on accumulated operational data.

Third, existing systems that attempt to employ generative models for creating event content or advertising text often treat prompt sentences as static text prepared by operators, or they rely on generic templates that do not reflect the current data distributions, learned visitor clusters, or operator preferences. These approaches fail to exploit structured analysis results and decision histories in a machine-readable form to dynamically shape prompt sentences. As a result, the interaction between the analytics engine and the generative engine is weak, leading to content that is poorly aligned with actual visitor segments, time periods, and facility constraints. Furthermore, because templates for prompt sentences are not adaptively updated based on approval or modification histories, the system cannot converge toward prompt structures that systematically yield higher-quality generative outputs.

Fourth, feedback from external terminal devices, such as approvals, rejections, and modifications of proposed events and staffing plans, is often handled in separate business tools or communication channels, and is not integrated into the data pipeline in a structured manner. This disconnect prevents the system from using such feedback as training signals to adjust both the machine learning models and the prompt generation logic. Accordingly, the computer fails to leverage a closed feedback loop that would otherwise improve its internal representations, reduce error rates in predictions, and better adapt generated content to user preferences and operational constraints.

Therefore, there is a need for a computer-implemented system that unifies acquisition of user data, preprocessing, machine learning analysis, event and staffing planning, prompt sentence generation for a generative model, and feedback-driven model and template updates into a coherent processing pipeline. Such a system should use structured data flows and automated learning mechanisms so that the computer itself, rather than human operators, can iteratively refine prediction accuracy and content relevance. By tightly integrating these components, the system should improve computational efficiency, reduce manual intervention, and enhance the quality and effectiveness of event proposals and generated content.

The specific processing by the specific processing unit 290 of the data processing device 12 in Application Example 1 is realized by the following means.

The present invention provides a server comprising a processor configured to acquire user data including time-series information and attribute information via a communication network and store the user data in a storage, to perform preprocessing on the stored user data including data structure conversion and missing-value processing and to calculate, by aggregation processing and feature generation processing, attraction indices by time period and by attribute, to execute, on the basis of the attraction indices and the preprocessed user data, machine learning processing including clustering processing and prediction processing to extract user groups indicating visit tendencies and event participation tendencies and to calculate a predicted number of visits for each time period and a predicted participation probability, to generate, on the basis of the extracted user groups and the predicted number of visits, event candidate information including an event type candidate, a target user group, a scheduled time period, and a predicted number of participants and to calculate, on the basis of the predicted number of participants and a pre-stored staffing rule, a required number of personnel for each event, to generate, on the basis of the event candidate information and the required number of personnel, a prompt sentence in a natural language including an event objective, a target user group, a scheduled time period, and constraint conditions, to input the prompt sentence to a generative information processing model and store, in association with the event candidate information, an event content proposal and an advertising text acquired from the generative information processing model, to generate proposal information including the event candidate information, the required number of personnel, and the content acquired from the generative information processing model as display data and transmit the display data to an external terminal device, and to store, in association with the proposal information, approval information or modification information acquired from the external terminal device and update at least part of the machine learning processing and prompt sentence generation processing on the basis of a result of the storing. This enables the server to implement an integrated and automated feedback loop in which structured user data, predictive analytics, event planning, generative content creation, and operator feedback are processed coherently, thereby improving the accuracy of visit and participation predictions, reducing manual configuration of models and prompts, and enhancing the alignment and effectiveness of generated event content and staffing recommendations in a computer-technical manner.

The term “user data” refers to information related to an individual or group accessing or visiting a facility or service, including at least time-series information indicating when access or visits occur and attribute information indicating characteristics such as demographic or behavioral attributes.

The term “time-series information” refers to data elements that are associated with temporal indicators, such as timestamps, time intervals, or time periods, enabling chronological ordering and analysis of events or records.

The term “attribute information” refers to data elements that describe properties or characteristics of a user or event, including but not limited to demographic attributes, behavioral attributes, preference attributes, and identifiers used for grouping and analysis.

The term “storage” refers to a hardware or software component configured to persistently or semi-persistently store digital data, including non-transitory storage media such as semiconductor memory, magnetic storage, or optical storage, and logical constructs such as databases or file systems.

The term “preprocessing” refers to a series of operations performed on raw data to prepare the data for subsequent analysis or model processing, including at least data structure conversion and missing-value processing.

The term “data structure conversion” refers to transforming data from one structural representation to another, such as transforming unstructured or semi-structured records into tabular form, normalizing schemas, or converting data types to formats suitable for computation.

The term “missing-value processing” refers to detecting the absence of expected data elements and applying operations such as deletion, imputation, substitution, or flagging of records to handle such missing elements in a defined manner.

The term “aggregation processing” refers to computing summarized values from multiple data records or groups of records, such as counts, averages, totals, ratios, or other statistical measures for specified categories or time periods.

The term “feature generation processing” refers to deriving additional data attributes, called features, from existing data by applying transformations, combinations, or domain-specific rules in order to improve the performance or expressiveness of subsequent machine learning or analytical processing.

The term “attraction indices” refers to numerical or categorical indicators representing the degree or level of visitor presence, engagement, or interest in a facility, service, or event, computed per time period and per attribute category based on aggregated user data.

The term “machine learning processing” refers to computational procedures that enable a model to learn patterns or relationships from data and to output predictions, classifications, or other inferred results, including training, inference, and model updating.

The term “clustering processing” refers to an unsupervised learning procedure in which data points are grouped into clusters such that data points within a cluster are more similar to each other, according to a similarity or distance metric, than to data points in other clusters.

The term “prediction processing” refers to a supervised or semi-supervised learning procedure in which a model estimates unknown values, such as future visit counts or probabilities of event participation, based on learned relationships between input features and output variables.

The term “user group” refers to a subset of users that is identified or defined based on one or more criteria, such as similarity in time-series behavior, attribute information, or model-detected patterns, and that is treated as a segment for analysis or targeting.

The term “visit tendency” refers to a pattern describing how often and at what times or conditions users of a user group access or visit a facility or service.

The term “event participation tendency” refers to a pattern describing the likelihood or behavior of users of a user group in participating in events, promotions, or activities offered by a facility or service.

The term “predicted number of visits” refers to a quantitative estimation produced by prediction processing that indicates how many visits are expected to occur during a given time period.

The term “predicted participation probability” refers to a numerical value produced by prediction processing that represents the estimated likelihood that a user or user group will participate in a given event or activity.

The term “event candidate information” refers to structured data representing a proposed event or activity, including at least an event type candidate, a target user group, a scheduled time period, and a predicted number of participants.

The term “event type candidate” refers to a classification or label indicating a kind of event or activity that may be conducted, such as a demonstration, workshop, promotion, or performance.

The term “target user group” refers to a user group that is identified as a primary intended audience or participant population for a given event type candidate.

The term “scheduled time period” refers to a time interval during which an event or activity is planned or proposed to be held.

The term “predicted number of participants” refers to a quantitative estimation, derived from prediction processing and event candidate information, of how many users are expected to participate in a proposed event.

The term “staffing rule” refers to a predefined rule or set of rules specifying how to determine required personnel counts or roles based on one or more parameters, such as predicted number of participants, event type, or time period.

The term “required number of personnel” refers to a computed quantity of human resources that are deemed necessary to conduct an event or activity in accordance with at least one staffing rule.

The term “prompt sentence” refers to a text sequence in a natural language that is provided as input to a generative information processing model to instruct or guide the generation of content.

The term “constraint conditions” refers to conditions or limitations that apply to an event or generated content, such as budget limits, duration limits, resource availability, or facility policies, and that are reflected in the prompt sentence or event candidate information.

The term “generative information processing model” refers to a model, such as a generative artificial intelligence model, that generates text or other content in response to an input prompt by probabilistically determining subsequent tokens or structures based on learned patterns.

The term “event content proposal” refers to a set of generated information describing an event, including at least a concept, outline, schedule, or recommended structure, which is obtained from a generative information processing model.

The term “advertising text” refers to generated textual content intended for use in promotion or marketing of an event or activity, such as slogans, descriptions, or messages for display or distribution channels.

The term “proposal information” refers to composite data that includes event candidate information, required number of personnel, and at least part of the content, such as event content proposals and advertising texts, obtained from the generative information processing model.

The term “display data” refers to data formatted or arranged in a manner suitable for presentation on a user interface of an external terminal device, including layouts, textual elements, and structured fields required for display.

The term “external terminal device” refers to an information processing device external to the server, such as a client device including a display and user interface, configured to receive display data, present proposal information, and transmit user inputs such as approvals or modifications.

The term “approval information” refers to data indicating that all or part of proposal information has been accepted or confirmed for implementation by a user operating an external terminal device.

The term “modification information” refers to data indicating a change to proposal information, such as adjustments to event parameters, time periods, or staffing levels, as input by a user operating an external terminal device.

The term “teacher data” refers to labeled data used for training or retraining a prediction model, where input data are associated with known outputs such as participation results or sales results for supervised learning.

The term “participation result information” refers to data indicating the actual outcome of event participation, such as actual attendance counts, participation rates, or completion indicators associated with users or user groups.

The term “sales result information” refers to data indicating actual sales outcomes associated with events, time periods, or user groups, including at least sales amounts, transaction counts, or product categories sold.

The term “templates” refers to predefined patterns or structures of prompt sentences or other text, in which variable fields can be filled with specific values such as event type, target user group, or scheduled time period to produce a complete prompt sentence.

The term “past proposal information” refers to proposal information that has been previously generated by the system and for which corresponding approval information or modification information has been recorded.

The term “dynamic generation” refers to producing a prompt sentence or other content at runtime by selecting or modifying templates and populating variable elements based on current data, analysis results, or feedback information, rather than using fixed, static text.

In one embodiment, a server, a terminal, and a user cooperate to implement the invention as a computer-implemented system for generating and refining event proposals and related content. The server includes at least one processor, a main memory, a non-transitory storage device, and a network interface. The terminal includes a processor, a display, an input interface such as a touch panel, and a communication module. The user operates the terminal to review and adjust proposals generated by the server.

The server uses a general-purpose computing platform, for example a rack-mounted computer or a virtual machine operating on a cloud computing infrastructure. The server executes an operating system such as a general-purpose server operating system, and runs application software implemented in a programming language such as Python. The server stores user data and analysis results in a database management system, for example a document-oriented database or a relational database. The server optionally uses a real-time database service to receive user data from edge devices in substantially real time.

The server implements data handling modules that manage user data. The server acquires user data including time-series information and attribute information via a communication network. The server receives, for example, records including fields such as a visit timestamp, a user attribute vector (e.g., age group, demographic category, interest category), a facility area identifier, and an event participation flag. The server stores these records in a structured data store using a data schema in which each record is associated with a primary key and indexed by time. The server maintains tables or collections such as a “raw user data” collection, a “preprocessed user data” collection, and an “event decision history” collection.

The server uses a software library for data manipulation, such as a tabular data manipulation library, to perform preprocessing. The server converts raw records, which may be in a semi-structured format such as JSON, into a columnar table format in main memory. The server performs data structure conversion by mapping nested keys to flat columns, converting string-encoded timestamps into numeric epoch values, and encoding categorical attributes into numerical indices. The server performs missing-value processing by detecting null fields, invalid types, and out-of-range values, and applying predefined rules such as row deletion, median imputation, or insertion of sentinel values. The server generates derivative features, for example hour-of-day, day-of-week, a time-slot index, and composite demographic segments. By performing these conversions at the server using a vectorized computation library, the server reduces per-record overhead and improves both throughput and cache locality compared to row-wise manual processing.

The server calculates attraction indices by time period and by attribute using aggregation processing. The server groups the preprocessed records by time-slot index and attribute categories (e.g., demographic group identifiers), and computes measures such as counts of visits, ratios of event participation, and normalized engagement scores. The server represents these attraction indices as numerical arrays or matrices stored in memory. Because the server keeps the attraction indices in a compact numeric format, the server can perform downstream machine learning operations on cache-resident matrices without repeated database queries, thereby reducing latency and network load.

The server performs machine learning processing using a machine learning library such as a numerical machine learning framework. In one embodiment, the server executes clustering processing using an unsupervised learning algorithm such as k-means clustering. The server constructs a feature matrix in which each row represents a user or a group of visits, and each column represents a numerical feature derived from the user data and attraction indices. The server initializes cluster centroids and iteratively computes distances between user vectors and centroids, assigning users to clusters and updating centroids until convergence. The server thereby extracts user groups that exhibit similar visit tendencies and event participation tendencies. The server stores the resulting cluster assignments as cluster identifiers and uses these identifiers as segment labels.

The server also performs prediction processing using a supervised learning algorithm. In one embodiment, the server uses a gradient-boosted decision tree model or a multi-layer neural network to predict a predicted number of visits per time period and a predicted participation probability for each user group. The server constructs training examples by pairing historical feature vectors with target values such as actual visit counts or binary participation labels.

The server defines a loss function such as mean squared error for visit count prediction or cross-entropy loss for participation probability. The server performs gradient-based optimization to update model parameters, repeating forward and backward passes over the training data. The server may perform data augmentation by combining adjacent time slots or by adding noise to non-critical numeric features to improve generalization. The server stores the trained model parameters and version information in a model repository.

The server periodically retrains or fine-tunes the prediction model using new teacher data.

The server acquires participation result information and sales result information from the terminal and associates these results with corresponding time-series information and attribute information. The server uses these labeled records as additional training examples, and the server updates model parameters by performing incremental training. Because the server maintains a continuous training pipeline inside the same computational environment as the data preprocessing and aggregation, the server can adapt model behavior to recent operational conditions without requiring manual export and re-import of data. This integrated approach reduces synchronization errors and improves prediction accuracy over time.

The server generates event candidate information using rule-based logic implemented in the application layer. The server references the predicted number of visits, the predicted participation probability, and the extracted user groups. The server computes a predicted number of participants for a candidate event by multiplying the predicted number of visits by the predicted participation probability for the relevant user group and time slot. The server accesses a configurable rule set (staffing rule) stored in the storage. For example, the rule set may specify a number of personnel required per unit of predicted participants, and minimum and maximum staffing thresholds. The server calculates a required number of personnel by applying these rules and rounding up to the nearest integer. The server generates event candidate information objects that include identifiers for an event type candidate, the target user group, the scheduled time period, the predicted number of participants, and the required number of personnel.

The server generates a prompt sentence in a natural language based on the event candidate information. The server maintains a set of templates for prompt sentences, where each template is a text pattern containing variable placeholders for elements such as event objective, target user group, scheduled time period, constraints, and desired output format.

The server selects a template based on the event type candidate, the target user group, and the scheduled time period. The server may modify a template by adjusting phrasing or adding constraints in response to historical approval information and modification information. The server fills the placeholders with concrete values using the event candidate information, thereby generating a specific prompt sentence to supply as an input to a generative AI model.

The server uses a generative AI model, for example a large-scale language model implemented as a multi-layer transformer neural network, to generate event content proposals and advertising text. The server transmits the prompt sentence to the generative AI model through an inference interface such as a model-serving API. The generative AI model processes the prompt sentence by encoding tokens, applying self-attention layers, and producing probabilities over subsequent tokens. The server configures generation parameters such as sampling temperature, maximum length, and top-k or top-p thresholds to control output variability. The server receives as output a sequence of tokens representing natural language text that describes an event concept, a program outline, and promotional wording.

The server stores the generated event content proposal and advertising text in association with the underlying event candidate information. The server links these data using a common event candidate identifier and persists them in the storage. The server then composes proposal information comprising the event candidate information, the required number of personnel, and at least part of the generated content. The server converts this proposal information into display data, for example by structuring it as a view model that can be rendered into a web page or application screen. The server transmits the display data to the terminal via the network interface using a protocol such as HTTPS.

The terminal receives the display data and renders it on the display using a browser or a dedicated client application. The terminal displays, for each event, information such as the event title, description, scheduled time period, target user group, predicted number of participants, required number of personnel, and advertising text. The terminal provides user interface components, such as buttons and input fields, by which the user can approve or reject proposals, change certain parameters, or input comments. The terminal transmits approval information or modification information to the server in a structured format.

The user operates the terminal to review the proposals and to provide feedback. The user can examine comparative proposals for different time slots, demographics, or event types. The user may, for example, change the scheduled time period from “3 μm-5 μm” to “4 μm-6 pm,” reduce the required number of personnel due to staffing constraints, or modify the event objective from “increase foot traffic” to “increase dwell time.” The user may also modify the tone or length of the advertising text. The terminal sends these modifications as modification information, linked to the corresponding proposal information identifier.

The server stores the approval information and modification information in association with the proposal information and event candidate identifiers. The server uses this feedback for two types of internal updates. First, the server uses participation result information and sales result information, combined with approved proposals, as teacher data for retraining prediction models, improving prediction of visit counts and participation probabilities. Second, the server analyzes patterns in approval information and modification information associated with different templates and event types. The server adjusts selection probabilities of templates or updates template parameters so that templates that historically yield high approval rates or minimal modifications are favored in future prompt sentence generation. In this manner, the server implements a feedback loop that strictly uses recorded data to adjust both numerical model parameters and discrete template behavior.

The server thereby improves technical performance of the computer system. Because the server uses preprocessed, feature-enriched data structures and maintains attraction indices and clustering results in memory, the server can respond to new user data with reduced latency. By retraining models with continuously updated teacher data, the server reduces prediction error for visit counts and participation probabilities, which in turn leads to more accurate event candidate generation and more efficient assignment of personnel. The integrated pipeline eliminates repeated manual data exports and transforms, reducing I/O overhead and data inconsistency. The adaptive prompt sentence generation mechanism reduces the number of iterations required to obtain acceptable content from the generative AI model, thereby reducing computational load at the model inference layer and decreasing total network traffic for repeated prompts.

In one concrete example, the server detects, based on historical user data, that a specific user group of women in their twenties frequently visits a facility between 3 μm and 5 μm on weekends and shows high participation in fashion-related events. The server computes high attraction indices for this user group and time slot, assigns the users to a “fashion-interest cluster,” and predicts a high predicted number of visits and participation probability. The server generates event candidate information proposing a fashion event for that time period, calculates the required number of personnel, and generates the following prompt sentence: “Please propose an attractive fashion show event concept for women in their twenties who visit the shopping mall between 3 μm and 5 μm, including a title, a program timeline of approximately 60 to 90 minutes, and a short promotional message for social media.” The server inputs this prompt sentence to the generative AI model and receives a detailed event content proposal and promotional text. The terminal displays these results to the user, who approves the concept but modifies the start time and slightly adjusts the staffing. The server records the approved concept and the changes, and later uses the actual participation data from the event as teacher data to retrain the prediction model. The server also increases the selection weight of the template pattern that yielded high approval, resulting in more efficient generation of future prompt sentences.

In another example, the server targets a different user group, such as families with children who visit primarily between 10 am and 12 μm. The server generates a prompt sentence such as:
“Given that the off-peak time is 10 am to 12 μm and the main demographic is families with children, please suggest a workshop-style event that encourages longer stays, including a schedule, staff roles, and an outline of activities.”

The server uses the response from the generative AI model to propose a family workshop, and the terminal presents this to the user. The server tracks whether such events lead to increased dwell time and uses the results to refine both event selection rules and model features, such as including additional features for child-related attributes or weekend flags. The server applies processing strategies and data structures that differ from conventional manual or semi-automated workflows. Instead of simply automating human decision steps, the server implements a technical architecture in which clustering results, prediction outputs, and feedback signals are integrated into a joint state that directly controls real-time selection of templates and configuration of generative AI model inputs. The server uses numerical optimization and machine learning to adapt internal parameters based on objective loss functions, thereby reducing errors in prediction and content alignment in a way that is not feasible through fixed rule-based systems alone. The server also reduces communication load by minimizing repeated, trial-and-error interactions with generative models through adaptive prompts tuned to facility-specific data.

Alternative embodiments can modify or extend the components while retaining the same core technical behavior. The server may use different clustering algorithms, such as hierarchical clustering or density-based clustering, to form user groups. The server may employ different supervised learning models, such as recurrent neural networks or convolutional networks, depending on the structure of time-series input. The server may also integrate hardware accelerators, such as graphics processing units or tensor processing units, to execute the machine learning processing and generative model inference more efficiently. The terminal may be implemented as a mobile device, a kiosk, or a desktop workstation.

The server may also incorporate rule-based modules that complement machine learning outputs. For example, the server may enforce facility-specific constraints such as maximum simultaneous events per area or blackout periods where events are not permitted. The server combines these constraints with prediction outputs using a non-linear selection algorithm that optimizes utility subject to constraints, thereby generating only feasible event proposals. This integrated optimization further contributes to reduced manual filtering and improved computational efficiency.

Through these configurations, the server, the terminal, and the user collectively implement embodiments of the invention that are concretely tied to computer technology. The server improves the way digital data are structured, processed, and used to control downstream generative AI calls and staffing calculations. The resulting system provides measurable technical effects, including improved prediction accuracy, reduced processing latency, more efficient memory utilization, and reduced communication overhead, beyond mere automation of a human planner's reasoning.

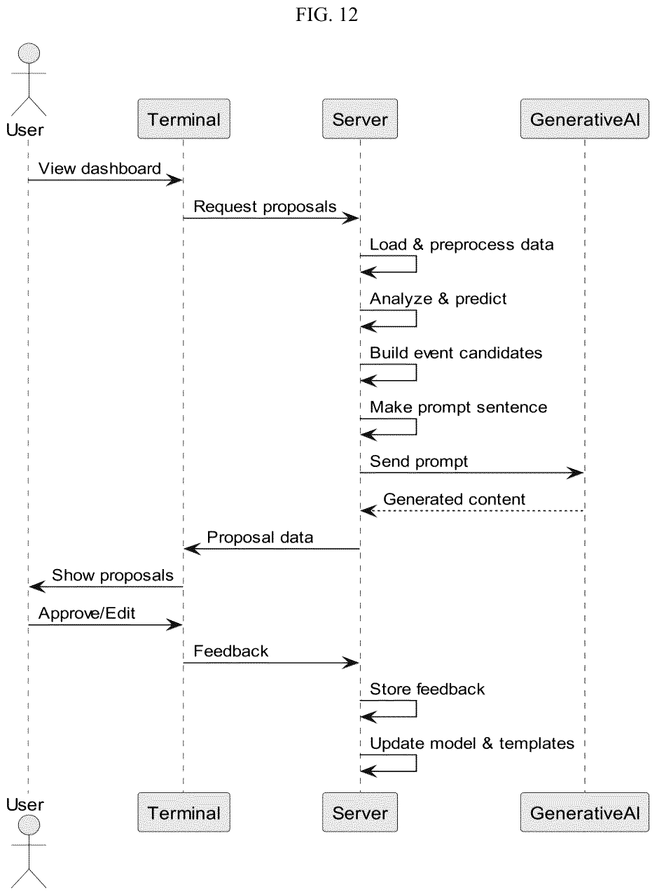

The following describes the processing flow using FIG. 12.

### Step 1:

The server acquires raw user data via a communication network.

The server receives, as input, individual records including at least a timestamp, an identifier of a user or session, attribute information (such as demographic category codes), and optional flags representing participation or purchase events.

The server parses incoming messages, validates required fields and data types, discards or flags invalid records, and assigns internal identifiers and ingestion timestamps.

The server outputs validated raw user data records and stores them in a structured data store such as a table or collection indexed by time and user identifier.

### Step 2:

The server preprocesses the stored raw user data to generate a structured dataset suitable for analysis.

The server reads, as input, a batch of raw user data records from the storage within a specified time range.

The server converts semi-structured fields (such as JSON payloads) into a tabular format, converts textual timestamps into numeric time representations, normalizes category labels, and encodes categorical attributes as numerical indices or one-hot vectors.

The server performs missing-value processing by detecting null or invalid entries, applying deletion, imputation, or sentinel-value insertion according to predefined rules.

The server derives additional features such as hour-of-day, day-of-week, time-slot index, and composite demographic segments.

The server outputs a preprocessed dataset represented as a feature table in memory and stores a copy in a “preprocessed data” area of the storage.

### Step 3:

The server calculates attraction indices by time period and attribute category.

The server takes, as input, the preprocessed dataset containing enriched time and attribute features.

The server groups records by time-slot index and by attribute categories (for example, demographic segment code and area identifier), and computes aggregate metrics including visit counts, participation ratios, and normalized engagement scores.

The server stores these aggregate metrics in numeric arrays or matrices keyed by time-slot and segment identifiers.

The server outputs attraction indices that summarize visitor presence and engagement across time and segments.

### Step 4:

The server performs clustering processing to extract user groups with similar visit and participation tendencies.

The server uses, as input, the preprocessed dataset and the attraction indices.

The server constructs a feature matrix where each row corresponds to a user or a user-segment/time-slot combination and each column represents a numeric feature such as visit frequency, participation ratio, and encoded attributes.

The server runs an unsupervised clustering algorithm (for example, k-means) that repeatedly assigns feature vectors to cluster centroids and updates centroids until convergence.

The server assigns a cluster identifier to each user or segment and records cluster characteristics such as typical time-slots and average participation tendencies.

The server outputs a set of user groups represented by cluster identifiers and associated feature summaries.

### Step 5:

The server performs prediction processing to estimate visit counts and participation probabilities.

The server takes, as input, the preprocessed dataset, the attraction indices, the user group assignments, and historical participation or sales result information stored in association with past time periods.

The server constructs training feature vectors that include time features, attribute features, group identifiers, and prior engagement measures, and pairs them with target output values such as actual visit counts or participation labels.

The server trains or updates a prediction model by computing a loss function (such as mean squared error or cross-entropy), calculating gradients, and adjusting model parameters.

The server applies the trained model to current and future time-slots to compute, for each user group and time-slot, a predicted number of visits and a predicted participation probability.

The server outputs prediction results as numeric predictions indexed by time-slot and group identifiers and stores them in the storage.

### Step 6:

The server generates event candidate information and calculates required personnel based on prediction results.

The server uses, as input, the predicted number of visits, the predicted participation probabilities, the user group definitions, and a stored staffing rule set.

The server computes a predicted number of participants for each potential event by multiplying the predicted visit count by the predicted participation probability for a given user group and time-slot.

The server applies staffing rules that map expected participants and event type categories to required personnel, enforcing minimum and maximum constraints and rounding up to allocate sufficient staff.

The server creates event candidate records that include an event type candidate, a target user group identifier, a scheduled time period, the predicted number of participants, and the required number of personnel.

The server outputs a list of event candidate information objects and stores them in the storage for further processing.

### Step 7:

The server generates a prompt sentence in a natural language for each event candidate.

The server reads, as input, the event candidate information, template definitions for prompt sentences, and historical approval or modification information associated with past proposals.

The server selects or adjusts a prompt template based on the event type candidate, the target user group, and the scheduled time period, weighting templates that historically led to high approval rates or fewer modifications.

The server fills the template placeholders with specific values such as an event objective, the demographic description of the target user group, the concrete time interval, and any constraint conditions (for example, budget limits or duration limits).

The server constructs a complete prompt sentence, for example:
“Please propose an attractive fashion show event concept for women in their twenties who visit the shopping mall between 3 μm and 5 μm, including a title, a program timeline of approximately 60 to 90 minutes, and a short promotional message for social media.”

The server outputs the generated prompt sentence as a text string associated with the corresponding event candidate.

### Step 8:

The server obtains generated content from a generative AI model using the prompt sentence.

The server sends, as input, the prompt sentence to a generative AI model via an inference interface, along with generation parameters such as maximum output length and sampling configuration.

The server receives, as output, a sequence of tokens forming at least one event content proposal (for example, event title and structured description) and an advertising text suitable for promotional use.

The server links the generated content to the underlying event candidate by storing it with a shared identifier.

The server outputs enriched event candidate records that contain both analytical data (predictions and staffing) and content data (event description and advertising text).

### Step 9:

The server composes proposal information and prepares display data for the terminal.

The server takes, as input, the enriched event candidate records and any additional facility constraints or context information.

The server aggregates, for each candidate, all associated data including user group descriptors, time-slots, predicted participants, required personnel, and generated texts, and converts them into a display-oriented structure such as a serializable object or document.

The server may compute derived values such as relative priority scores or comparative metrics to assist user decision-making.

The server outputs display data and transmits it to the terminal via a network protocol.

### Step 10:

The terminal receives and renders proposal information to the user.

The terminal takes, as input, the display data transmitted by the server.

The terminal parses the received data, constructs user interface elements such as lists, detail views, and charts, and displays, on the screen, proposal information for each event candidate, including the generated event content proposal and advertising text.

The terminal provides interactive controls enabling the user to approve or reject events, modify parameters such as time-slot or staffing, and edit generated texts when necessary.

The terminal outputs user interaction events and collects approval information and modification information for each proposal.

### Step 11:

The user reviews, adjusts, and decides on the proposals via the terminal.

The user reads, as input, the proposal information presented on the terminal, including predicted metrics, staffing estimates, and the generative AI model's proposed content.

The user compares alternatives, considers constraints such as available staff and facility schedules, and, using the terminal interface, selects actions such as “approve,” “reject,” or “edit.”

The user may adjust fields such as scheduled time period, required number of personnel, or specific phrasing in the advertising text.

The user outputs, through the terminal, explicit approval information or modification information for each proposal to be sent back to the server.

### Step 12:

The terminal transmits user feedback to the server.

The terminal receives, as input, the user's actions and edited data elements.

The terminal packages this information into structured feedback messages containing proposal identifiers, decision statuses, and modified fields, and sends these messages to the server over the communication network.

The terminal outputs feedback data that faithfully represents the user's decisions for server-side processing.

### Step 13:

The server records feedback and updates models and templates.

The server takes, as input, the feedback data from the terminal, including approval information, modification information, participation result information, and sales result information collected after events occur.

The server writes these data into persistent storage, associating them with the corresponding proposal information, event candidate, time-series information, and attribute information.

The server selects portions of the recorded data as teacher data for retraining the prediction model, recalculates loss functions using updated labels, and adjusts model parameters to reduce prediction error.

The server analyzes correlations between approval or modification patterns and prompt templates, increases selection probabilities for templates with favorable outcomes, and adjusts template text where high modification rates indicate a mismatch.

The server outputs updated model parameters and template configurations, which are then used in subsequent executions of prediction processing and prompt sentence generation, thereby closing the feedback loop.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for planning events and personnel allocation in facilities, such as commercial facilities or public spaces, typically rely on manually designed rules or static configuration data. In such systems, a processor often treats heterogeneous facility data, including visitor tracking data, transaction data, and stay duration data, as loosely coupled log information that is analyzed in isolation or with minimal preprocessing. As a result, noise, missing values, and outliers in the data are propagated into subsequent processing stages, thereby degrading the accuracy of behavior analysis and prediction. Furthermore, existing systems generally generate event plans and staffing plans using simple templates or manually authored content, without exploiting the expressiveness and adaptability of generative models conditioned on detailed, structured analysis of visitor behavior.

In addition, many existing solutions handle visitor segmentation, time-based traffic analysis, content generation, and staffing optimization as separate subsystems. This fragmented architecture causes redundant data transformations, inconsistent use of behavioral features, and increased latency, and makes it difficult to close the feedback loop from actual operational outcomes back into the analysis pipeline. Consequently, it becomes difficult for the processor to update models and content generation logic based on real-world execution results and user evaluations, which limits continuous improvement of system performance. From a computer-technology perspective, there is a need for an improved data processing architecture in which a processor:
(1) systematically acquires, cleans, and transforms raw multi-source facility data into feature-level preprocessed data suitable for machine learning,
(2) performs integrated behavioral segmentation and time-series estimation to produce machine-usable analytical representations,
(3) automatically converts such analytical representations into structured natural-language prompt sentences for a generative AI model,
(4) uses the responses of the generative AI model as first-class machine-processable objects that can be linked back to segments, time periods, and resource constraints, and
(5) incorporates user feedback and operational outcomes into the same data pipeline to improve subsequent analyses and generated prompt sentences.

Without such an integrated, computer-centric architecture, it is difficult to efficiently and reliably generate high-quality, segment-specific event content and optimized personnel allocation plans, and to continuously adapt these outputs to evolving visitor behavior and operational constraints. Therefore, there is a demand for a system and a processor configuration that technically improve the way computers collect, preprocess, analyze, and exploit facility data in conjunction with generative AI models, thereby enhancing both the accuracy and efficiency of event planning and personnel allocation processes.

The specific processing by the specific processing unit 290 of the data processing device 12 in Example 2 is realized by the following means.

The present invention provides a server comprising a processor configured to acquire facility-related information from detection devices and storage devices, store the information as raw data including identification information related to visitors, information related to purchases, and information related to stays in association with time information and area information, and accumulate the raw data; to perform preprocessing on the raw data by complementing information related to missing values, removing information related to abnormal values, and performing encoding of classification attributes and normalization of numerical attributes so as to generate behavior-related feature values, and store the behavior-related feature values as preprocessed data; to execute, on the basis of the preprocessed data, a classification process and a time-related estimation process using a machine learning model so as to generate an analysis result including segments related to visitor behavior and temporal tendencies related to customer attraction; to aggregate the analysis result into a structured internal representation, generate, on the basis of the internal representation, a prompt sentence in natural language including a target visitor segment, information related to a time period, and an operational objective, and input the prompt sentence to a generative AI model so as to obtain event-related content and operation-related proposals; to analyze the event-related content and the operation-related proposals obtained from the generative AI model, store each proposal in association with a corresponding visitor segment and time period, and present the proposals to a user via a display device; to estimate, on the basis of the analysis result and the event-related content, required personnel numbers for each time period and each area, generate a personnel allocation plan by using an optimization algorithm, and present the personnel allocation plan to the user; and to acquire, from a terminal device used by the user, correction information or evaluation information related to the event-related content and the personnel allocation plan, store the correction information or the evaluation information in association with the raw data or the preprocessed data, and reflect the correction information or the evaluation information in a subsequent analysis result and in subsequent generation of the prompt sentence. This enables a computer-implemented pipeline in which heterogeneous facility data is systematically cleaned and transformed into feature-level preprocessed data, analyzed to produce structured behavioral and temporal representations, converted into targeted natural-language prompt sentences for a generative AI model, and coupled with optimization-based personnel allocation, while user feedback and operational outcomes are fed back into the same pipeline, thereby improving the technical performance, accuracy, and adaptability of event content generation and staffing optimization.

The term “facility-related information” refers to information representing a state or event occurring in a facility, including but not limited to visitor presence, visitor movement, purchase activity, and stay duration, which is acquired from one or more devices or storage units installed in or associated with the facility.

The term “detection device” refers to any hardware device configured to detect or measure physical or digital events in or around a facility, including but not limited to sensors, cameras, counters, and transaction terminals.

The term “storage device” refers to any hardware or logical component configured to store data, including but not limited to databases, storage media, and data repositories accessible to the server.

The term “raw data” refers to data directly acquired from detection devices and storage devices before being subjected to preprocessing, the raw data including identification information related to visitors, information related to purchases, information related to stays, and associated time and area information.

The term “identification information related to visitors” refers to information that distinguishes one visitor or group of visitors from another, including but not limited to identifiers derived from sensors, cameras, or communication devices, or anonymized identifiers associated with visitor behavior records.

The term “information related to purchases” refers to data representing transactions performed in the facility, including but not limited to purchased items, amounts, times of purchase, and locations of purchase.

The term “information related to stays” refers to data representing the presence or movement of a visitor within a facility, including but not limited to entry time, exit time, dwell time in specific areas, and paths between areas.

The term “time information” refers to data indicating a point in time or a time period associated with an event, including but not limited to timestamps and time intervals.

The term “area information” refers to data indicating a physical region or zone within a facility, including but not limited to floor identifiers, zone identifiers, and store or section identifiers.

The term “preprocessing” refers to a sequence of processing operations performed on raw data prior to analysis, including but not limited to complementing missing values, removing abnormal values, encoding classification attributes, and normalizing numerical attributes.

The term “information related to missing values” refers to data fields in which expected values are absent, undefined, or invalid and that require completion or substitution as part of preprocessing.

The term “information related to abnormal values” refers to data values that deviate from expected ranges or patterns and that are treated as outliers or errors during preprocessing.

The term “encoding of classification attributes” refers to transforming categorical or qualitative attributes into a numerical or structured representation suitable for machine processing, including but not limited to one-hot encoding, label encoding, and embedding representations.

The term “normalization of numerical attributes” refers to transforming numerical values according to a predetermined rule, including but not limited to scaling, standardization, or range limitation, to improve machine learning performance or stability.

The term “behavior-related feature values” refers to derived values computed from raw data that represent characteristics of visitor behavior, including but not limited to visit frequency, average spend, typical visit time, and area preference.

The term “preprocessed data” refers to data obtained after applying preprocessing to raw data, including behavior-related feature values and other cleaned and transformed attributes suitable for analysis or model input.

The term “classification process” refers to processing using a machine learning model to assign data records or visitors into segments or categories based on their attributes or behavior.

The term “time-related estimation process” refers to processing using a machine learning model or statistical method to estimate temporal patterns, including but not limited to predicting visitor numbers, traffic levels, or event impacts for specific time periods.

The term “machine learning model” refers to a computational model trained on data to perform prediction, classification, clustering, or estimation, including but not limited to supervised, unsupervised, and reinforcement learning models.

The term “analysis result” refers to data produced by the classification process and the time-related estimation process, including but not limited to visitor behavior segments and temporal tendencies related to customer attraction.

The term “segment related to visitor behavior” refers to a group or category of visitors defined according to similarities in their behavior, attributes, or preferences, as determined by the classification process.

The term “temporal tendencies related to customer attraction” refers to patterns in visitor numbers, behavior, or transactions over time, including but not limited to peak hours, low-traffic periods, and periodic trends.

The term “structured internal representation” refers to a machine-readable data structure, such as a record or document, that aggregates and organizes the analysis result in a form suitable for subsequent processing, including the generation of prompt sentences.

The term “prompt sentence” refers to a natural-language expression generated on the basis of the structured internal representation, the prompt sentence being configured to be input to a generative AI model to request generation of event-related content or operation-related proposals.

The term “natural language” refers to a human language, such as English or another human-readable language, that can be interpreted by a generative AI model configured for natural language processing.

The term “target visitor segment” refers to a particular segment related to visitor behavior that is designated in a prompt sentence as the primary audience or focus for an event or operational proposal.

The term “information related to a time period” refers to data indicating a specific time window or range, such as a daily time slot or date range, that is included in a prompt sentence and relevant to an event or operational proposal.

The term “operational objective” refers to a management or operational goal associated with facility operation, including but not limited to increasing visitor numbers, improving conversion rates, or optimizing resource use.

The term “generative AI model” refers to an artificial intelligence model configured to generate text or other content in response to input data or prompt sentences, using learned patterns from training data.

The term “event-related content” refers to information generated by the generative AI model that describes or specifies an event to be conducted in the facility, including but not limited to event descriptions, schedules, locations, and required resources.

The term “operation-related proposal” refers to information generated by the generative AI model that proposes an operational action or plan, including but not limited to marketing actions, layout adjustments, or management strategies.

The term “display device” refers to any device or component configured to present visual information to a user, including but not limited to a monitor, a screen of a terminal device, or a graphical user interface.

The term “personnel allocation plan” refers to a plan specifying the number and roles of personnel to be assigned to one or more areas of a facility for each time period, based on required personnel numbers and operational constraints.

The term “optimization algorithm” refers to a computational procedure configured to determine an improved or optimal solution for a given objective subject to constraints, including but not limited to linear programming, integer programming, or heuristic optimization methods.

The term “terminal device” refers to an information processing device operated by a user to access, view, or modify proposals or plans, including but not limited to a personal computer, a mobile device, or a tablet.

The term “correction information” refers to information input by a user to modify, adjust, or override event-related content or a personnel allocation plan generated by the system.

The term “evaluation information” refers to feedback data input by a user regarding performance, effectiveness, or suitability of event-related content or a personnel allocation plan.

The term “subsequent analysis result” refers to an analysis result generated after user feedback or additional data has been incorporated into the processing pipeline, following one or more prior analysis cycles.

The term “subsequent generation of the prompt sentence” refers to generation of one or more new prompt sentences after past prompt sentences and associated results have been updated based on correction information, evaluation information, or newly accumulated data.

In one embodiment, a server, a terminal, and a plurality of detection devices and storage devices are interconnected through a communication network in a facility such as a commercial complex or public venue. The server includes at least one processor, a main memory, a non-volatile storage unit, and a network interface. The terminal includes at least one processor, a display device, an input interface, and a communication module. The detection devices include, for example, people-counting sensors, cameras, and transaction terminals. The storage devices include, for example, database systems and file storage systems.

The server executes a program stored in the non-volatile storage unit and loaded into the main memory. The program defines modules for data acquisition, preprocessing, analysis, prompt sentence generation, generative AI model interaction, proposal management, personnel allocation optimization, and feedback incorporation.

The server uses the network interface to communicate with detection devices such as sensors and cameras installed in the facility. The server acquires facility-related information from the detection devices in the form of structured messages. The server also acquires transaction information and visitor-related records from storage devices such as relational database systems. The server stores the acquired data as raw data in storage structures such as relational tables and time-series logs, with each record including visitor identification information, purchase information, stay information, time information, and area information.

The server uses a data store implemented, for example, by a relational database management system to maintain tables for visits, transactions, visitor segments, and analysis results. The server associates each record with a unique key for a visitor or session and with a time stamp and a facility area identifier. The server stores raw data in a schema optimized for append operations and later transfers preprocessed data into a schema optimized for analytical queries.

The server performs preprocessing on the raw data using a data processing framework in the main memory. The server detects missing values in numeric fields and categorical fields by scanning for null or invalid entries. The server complements missing numerical values using a statistical estimator such as a median estimator computed per segment or per area, and complements missing categorical values using a probabilistic model estimated from historical distributions. The server detects abnormal values by applying statistical rules such as z-score thresholds or interquartile range thresholds and flags outliers for removal or capping. The server encodes categorical attributes such as age group, gender, and product category into numerical vectors using encoding schemes such as one-hot encoding or embedding indices, and normalizes numerical attributes such as purchase amount and dwell time using scaling functions such as min-max scaling or standardization.

The server generates behavior-related feature values from the cleaned and transformed attributes. The server computes feature values such as visit frequency, average purchase amount, typical visit time window, and distribution of visited areas. The server stores the resulting preprocessed data and feature values in dedicated tables. The server maintains index structures on keys such as visitor identifiers, time intervals, and area identifiers to enable efficient query and aggregation operations.

The server performs a classification process and a time-related estimation process on the preprocessed data using a machine learning model. In one embodiment, the server uses a clustering algorithm, such as k-means clustering implemented in a numerical computation library, to assign visitors or sessions to segments based on their feature vectors. The server initializes cluster centroids and iteratively updates them by minimizing a distance-based objective function until convergence. The server stores, for each visitor or session, a segment label representing a segment related to visitor behavior.

The server additionally performs a time-related estimation process using a time-series model. In one embodiment, the server uses a recurrent neural network architecture, such as a long short-term memory network, to estimate visitor counts or transaction volumes per time period. The server configures an input layer receiving sequences of time-stamped counts, one or more recurrent layers with gating mechanisms, and an output layer generating estimated counts for future time periods. The server trains the network by minimizing a loss function such as mean squared error over historical data and updates network weights using a gradient-based optimization algorithm. The server stores the resulting temporal tendencies related to customer attraction, such as predicted peak hours and low-traffic intervals.

The server aggregates the classification and temporal estimation results into a structured internal representation. The server constructs, for each combination of visitor segment and time period, a record including segment characteristics, predicted traffic levels, predominant product categories, and facility areas with high relevance. The server stores the internal representation in a document-oriented structure or table form to facilitate subsequent generation of prompt sentences.

The server generates a prompt sentence in natural language based on the structured internal representation. The server constructs textual content including a description of the target visitor segment, the relevant time period, and an operational objective. The server inserts analytical values such as dominant age group, typical purchase categories, and predicted visitor counts into the prompt sentence. For example, the server generates a prompt sentence such as:
“You are an event planner for a shopping mall.

For weekdays between 18:00 and 20:00, most visitors are women in their 20s who frequently purchase fashion accessories and cosmetics.

Propose three in-store event ideas that will increase both foot traffic and average spending for this time slot.

For each idea, provide:
1) Event title,
2) Short description,
3) Recommended in-mall location,
4) Required staff roles and estimated numbers,
5) Suggested promotional message.”

The server inputs the generated prompt sentence to a generative AI model through an interface. In one embodiment, the generative AI model is a transformer-based neural network having an encoder-decoder architecture with multiple attention layers, trained on a large corpus of natural language text. The server transmits the prompt sentence as a sequence of tokens and specifies parameters such as maximum output length and sampling temperature.

The server receives from the generative AI model a response that includes event-related content and operation-related proposals expressed in natural language.

The server analyzes the response from the generative AI model. The server parses the textual content by applying rules or natural language parsing techniques to extract structural elements such as event titles, descriptions, suggested locations, and required staff roles. The server maps each extracted element to corresponding fields in an event proposal data structure and associates each proposal with the relevant visitor segment and time period identified in the internal representation. The server stores the proposals in a proposal table and marks them with identifiers that link back to the original prompt sentence and analysis result.

The server estimates required personnel numbers for each time period and each area based on the analysis result and the event-related content. The server uses the predicted visitor counts and the required staff roles and numbers extracted from the event-related content to form demand vectors for personnel by role, by time segment, and by area. The server applies an optimization algorithm, such as an integer linear programming solver, to determine personnel allocation plans that satisfy the demand vectors while complying with constraints such as maximum working hours and skill requirements. The server encodes the problem as an objective function, for example minimizing total staffing cost or balancing workload, subject to constraints represented as linear inequalities. The server solves the optimization problem and outputs a personnel allocation plan specifying the number and roles of personnel for each time period and area.

The server presents the event-related content and the personnel allocation plan to the user via the terminal. The terminal displays lists and schedules on a graphical user interface and allows the user to view details of proposals and staffing plans. The terminal sends user operations, such as selection, approval, or modification of proposals and staffing plans, back to the server.

The user reviews the event proposals and personnel allocation plan displayed on the terminal.

The user may adjust event parameters such as event duration, area, or required staff roles by inputting changes through the terminal. The user may also provide evaluation information about previously executed events, including qualitative feedback and actual visitor numbers or sales figures.

The server receives correction information and evaluation information from the terminal. The server stores the correction information and evaluation information in association with the corresponding raw data, preprocessed data, and proposals. The server uses the stored feedback to update model parameters or to refine the generation of prompt sentences. For example, the server may adjust clustering parameters, retrain the recurrent neural network on updated time-series data, or update rules for extracting required staff from generative AI model outputs. The server may further generate a new prompt sentence that explicitly incorporates constraints or preferences indicated by the user, such as:
“Revise the following event plan to reduce the required staff by 30% while maintaining its appeal to women in their 20s during weekday evenings. Here is the current event plan: [event description].”

The server inputs the revised prompt sentence to the generative AI model and obtains an updated event-related content that respects the constraints. The server thereby realizes an iterative loop in which user feedback and operational outcomes influence subsequent analysis, prompt sentence generation, and generative AI outputs.

The server, by integrating preprocessing, analysis, generative content generation, and optimization within a unified data flow, improves computer performance beyond mere automation of human planning. The server reduces data noise and inconsistencies in early stages by applying structured preprocessing and feature engineering, thereby increasing the accuracy of machine learning models and reducing computational overhead during training and inference. The server utilizes specialized data structures and indices to accelerate query processing, which decreases response time in generating analysis results and prompt sentences. The server leverages the transformer-based generative AI model in a constrained manner by supplying structured prompt sentences derived from internal representations, which leads to more stable and relevant outputs and reduces the need for manual rewriting of event plans.

The server further improves computational efficiency by separating raw data storage from preprocessed data storage and by reusing preprocessed features in multiple analysis cycles. This design decreases redundant computations and reduces the overall load on the processor and memory. The server improves the management of event-related and staffing-related information by linking proposals and personnel plans to visitor segments, time periods, and operational outcomes using unique identifiers, which enhances traceability and enables targeted model updates. The system also reduces communication load between the server and the terminal by transmitting compact identifiers and summaries whenever full data sets are unnecessary, thereby lowering network bandwidth usage.

The server's use of machine learning models and generative AI models differs from simple rule-based or human-authored planning because the server applies non-conventional processing sequences and model-based inferences. The server converts numerical and categorical behavioral data into feature vectors, feeds these vectors into trained models with specific loss functions and update rules, and then translates model outputs into prompt sentences optimized for generative natural-language processing. This multi-stage computational pipeline cannot be feasibly replicated by manual operations and provides technical effects such as improved prediction accuracy, reduced error rates in planning, and faster generation of suitable proposals.

In one variation, the server employs different clustering algorithms or neural network architectures, such as density-based clustering or convolutional neural networks combined with recurrent layers, to better capture spatial-temporal patterns in visitor flows. In another variation, the server uses alternative optimization formulations, such as multi-objective optimization, to handle trade-offs between staffing cost and service quality. In yet another variation, the server deploys the generative AI model locally on specialized hardware and adjusts model parameters, such as the number of layers or attention heads, to satisfy latency constraints in real-time event planning.

The terminal may be implemented as a mobile device, a tablet, or a desktop workstation. The terminal communicates with the server using secure protocols and provides an interactive interface through which the user can monitor analysis results, review event-related content, and modify personnel allocation plans. In some embodiments, the terminal also displays real-time metrics collected from detection devices, enabling the user to compare predicted tendencies with actual visitor behavior.

The user operates the system by configuring facility preferences, initiating analysis cycles, and approving or editing generated content. However, the core technical operations, including data preprocessing, model-based analysis, prompt sentence generation, generative AI inference, and optimization, are executed by the server in accordance with the program logic.

As a result, the system realizes an improved computer-implemented framework in which raw facility data is transformed into actionable, high-precision event and staffing plans through specialized data structures, algorithms, and neural network processing that go beyond conventional manual or rule-based systems.

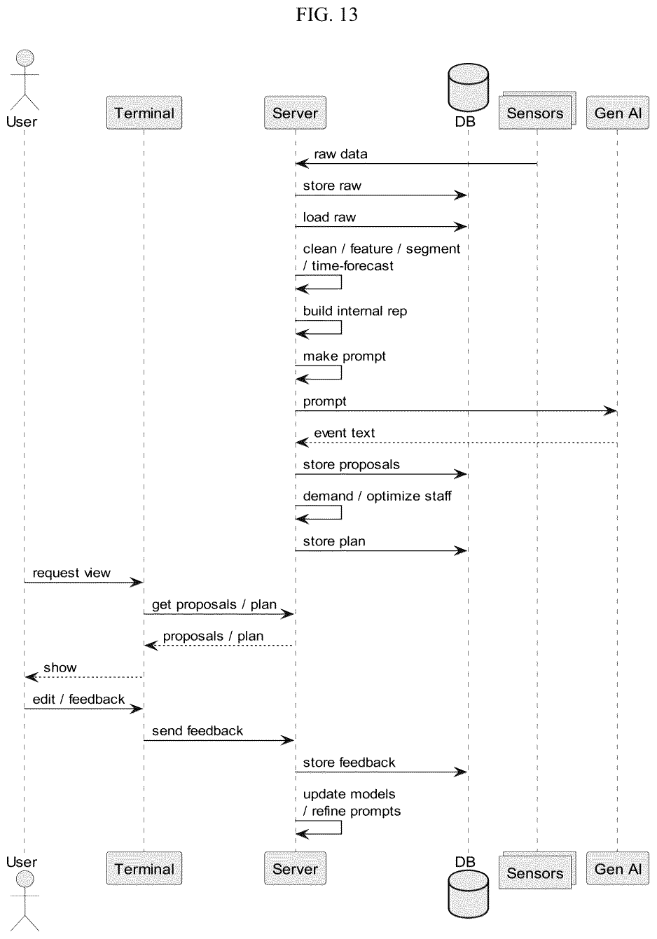

The following describes the processing flow using FIG. 13.

### Step 1:

The server acquires raw facility data from detection devices and storage devices.

The server receives, as input, sensor messages from people-counting sensors, image-derived metadata from cameras, and transaction records from transaction terminals and databases.

The server parses each input message to extract fields such as visitor identifier (or session identifier), purchase amount, product category, entry time, exit time, and area identifier.

The server then writes these values into raw-data tables, associating each record with time information and area information, and outputs a stored raw-data set that is indexed by visitor/session ID, timestamp, and area.

### Step 2:

The server preprocesses the raw data to remove noise and complete missing information.

The server reads, as input, raw-data records from the raw-data tables created in Step 1.

The server scans each column to detect missing values and abnormal values, calculates statistical measures (for example, mean, median, standard deviation, and interquartile range), and uses these measures to complement missing numerical values and categorical values, and to flag and either remove or cap outliers.

The server encodes categorical fields (such as age group, gender, and product category) into numerical vectors and normalizes numerical fields (such as purchase amount and dwell time), and outputs a cleaned, numerically encoded dataset as preprocessed data.

### Step 3:

The server generates behavior-related feature values from the preprocessed data.

The server receives, as input, the preprocessed data output from Step 2.

The server aggregates records per visitor or per session and computes derived metrics such as visit frequency, average purchase amount, variance of spending, typical visit time band, and distribution of visited areas.

The server concatenates these derived metrics and encoded attributes into feature vectors that represent visitor behavior, and outputs a feature-level dataset in which each row corresponds to a visitor or session and each column corresponds to a behavior-related feature value.

### Step 4:

The server performs visitor segmentation using a machine learning model.

The server takes, as input, the feature-level dataset produced in Step 3.

The server initializes parameters of a clustering algorithm, such as cluster centroids, and iteratively assigns each feature vector to the nearest centroid based on a distance metric and updates the centroids to minimize an objective function.

The server thus maps each visitor or session to a behavior segment identifier and outputs a segmented dataset that includes, for each visitor or session, the assigned segment label and the corresponding feature vector.

### Step 5:

The server performs time-related estimation of traffic patterns.

The server reads, as input, time-aggregated counts and transaction statistics derived from the preprocessed data of Step 2, grouped by time intervals and facility areas.

The server feeds sequences of time-stamped visitor counts and transaction amounts into a time-series model, such as a recurrent neural network, and computes predicted values for future time intervals by propagating the current input and hidden state through the network layers.

The server outputs a temporal tendencies dataset that includes, for each time interval and area, predicted visitor counts, expected transaction volume, and indicators of peak or low-traffic periods.

### Step 6:

The server builds a structured internal representation combining segments and temporal tendencies.

The server takes, as input, the segmented dataset from Step 4 and the temporal tendencies dataset from Step 5.

The server groups visitors by segment and cross-references the segments with time intervals during which each segment is dominant, using join and aggregation operations based on time and area identifiers.

The server constructs, for each dominant segment and time period pair, a record that includes segment characteristics, predicted traffic level, predominant product categories, and relevant facility areas, and outputs a structured internal representation that is suitable for prompt sentence generation.

### Step 7:

The server generates a prompt sentence in natural language based on the internal representation.

The server receives, as input, a selected record from the structured internal representation, indicating a target visitor segment, a time period, and associated behavioral statistics.

The server fills a predefined text template with the analytical values from the selected record, such as age group, gender distribution, preferred product categories, and predicted visitor counts, and constructs a coherent natural-language description that also includes an operational objective.

The server outputs a prompt sentence, for example:
“You are an event planner for a shopping mall.

For weekdays between 18:00 and 20:00, most visitors are women in their 20s who frequently purchase fashion accessories and cosmetics.

Propose three in-store event ideas that will increase both foot traffic and average spending for this time slot.

For each idea, provide:
1) Event title,
2) Short description,
3) Recommended in-mall location,
4) Required staff roles and estimated numbers,
5) Suggested promotional message.”

### Step 8:

The server inputs the prompt sentence to a generative AI model and obtains event-related content and operation-related proposals.

The server uses, as input, the prompt sentence generated in Step 7 and additional generation parameters (such as maximum output length and sampling temperature).

The server converts the prompt sentence into tokens, transmits the tokenized prompt and parameters to the generative AI model via an application programming interface, and waits for the model to process the input and generate a textual response.

The server outputs the generative AI model's response as raw event-related content and operation-related proposals in natural language.

### Step 9:

The server parses and structures the generative AI model's response into proposal objects.

The server receives, as input, the raw textual event-related content and operation-related proposals produced in Step 8.

The server applies parsing rules or natural language analysis to identify elements such as event titles, descriptions, suggested locations, required staff roles, estimated staff numbers, and promotional messages, then maps each element to fields in a proposal data schema.

The server associates each structured proposal object with the corresponding visitor segment and time period taken from the internal representation, and outputs a set of structured event proposals stored in a proposal repository.

### Step 10:

The server generates a personnel demand profile from the structured proposals and temporal tendencies.

The server takes, as input, the structured event proposals from Step 9 and the temporal tendencies dataset from Step 5.

The server, for each time interval and area where an event is proposed, calculates base staffing demand from the predicted visitor counts and adds incremental staffing requirements derived from the required staff roles and estimated numbers specified in the event proposals.

The server outputs personnel demand vectors by time interval, area, and role, which represent the total required personnel counts before optimization.

### Step 11:

The server computes a personnel allocation plan using an optimization algorithm.

The server receives, as input, the personnel demand vectors from Step 10 and constraint information describing available personnel resources, maximum working hours, and skill qualifications.

The server formulates an optimization problem where decision variables represent assignment of personnel to roles, areas, and time slots, constructs an objective function to minimize staffing cost or balance workload, and encodes constraints to ensure that demand vectors and personnel limitations are satisfied.

The server executes an optimization solver to find a feasible or optimal solution and outputs a personnel allocation plan that specifies, for each time interval and area, the number of personnel per role and the allocation of available personnel.

### Step 12:

The server transmits event proposals and the personnel allocation plan to the terminal for user review.

The server uses, as input, the structured event proposals from Step 9 and the personnel allocation plan from Step 11.

The server converts these objects into response messages formatted for the terminal, including summary fields (such as event titles and key staffing numbers) and identifiers linking to detailed records, and sends the messages over the network interface.

The server outputs transmitted data packets that the terminal can render on a graphical user interface.

### Step 13:

The terminal displays event proposals and the personnel allocation plan to the user.

The terminal receives, as input, the data packets sent by the server in Step 12.

The terminal decodes the packets, organizes the proposals in lists and calendars, and renders screens that show event details, associated visitor segments and time periods, and corresponding staffing schedules.

The terminal outputs visual displays and interactive user interface elements that allow the user to scroll, select, and edit proposals and allocation entries.

### Step 14:

The user reviews and optionally edits the event proposals and the personnel allocation plan.

The user takes, as input, the information displayed by the terminal in Step 13.

The user examines event content, time slots, locations, and staffing assignments, and may input modifications such as changing event times, adjusting required staff roles, or approving or rejecting specific proposals.

The user's actions result in updated event parameters and staffing constraints, which the terminal packages into modification messages as the output of this step.

### Step 15:

The terminal sends user correction information and evaluation information to the server.

The terminal uses, as input, the user modifications and feedback created in Step 14.

The terminal encodes corrections to event proposals, adjustments to staffing requirements, and evaluations of past events into structured messages with references to proposal identifiers and time intervals, and transmits these messages to the server via the communication module.

The terminal outputs network messages containing correction information and evaluation information addressed to the server.

### Step 16:

The server updates stored data and prepares feedback for subsequent analysis cycles.

The server receives, as input, the correction information and evaluation information sent by the terminal in Step 15.

The server writes the corrections to the proposal tables and personnel allocation records, associates evaluation information (such as actual visitor counts and satisfaction scores) with the corresponding raw data and preprocessed data entries, and logs these associations in feedback tables.

The server outputs updated datasets that incorporate user feedback and operational results, and uses these updated datasets as input for retraining or recalibrating models and for generating refined prompt sentences in future executions of Steps 2 through 8.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional facility management systems that attempt to increase visitor attraction typically rely on static rules, manually designed campaigns, and simple statistical dashboards. Such systems generally treat visitor count data, attribute data, and sentiment data as separate data streams and do not integrate them into a unified, machine-readable context. As a result, the systems cannot generate high-quality, situation-specific event plans or promotion plans in real time, and cannot adaptively optimize staffing or event content based on evolving visitor behavior.

In existing architectures, processors often execute isolated analytics pipelines: one pipeline for basic aggregation of visitor traffic from sensors and databases, another for coarse segmentation of visitor attributes from camera or identification devices, and yet another, if present at all, for sentiment estimation. These pipelines typically output human-readable reports but are not designed to feed structured, context-rich machine input to a downstream generative AI model. Consequently, the quality of automatically generated event content is heavily dependent on manually crafted input prompts, which are difficult to maintain, cannot scale with the data volume, and do not systematically improve from operational feedback. Further, conventional systems often implement generative models as disconnected services, triggered by ad hoc calls with generic prompts. The prompts are not derived from a formalized combination of real-time attraction tendencies, attribute segments, and emotion distributions, and the system does not maintain a feedback loop that correlates prompt patterns with realized performance metrics. This breaks the end-to-end optimization of the computing pipeline and prevents the processor from learning which prompt structures and context encodings are most effective.

In addition, known systems typically treat staffing optimization and event content generation as separate tasks, where staffing is based on coarse predicted visitor counts and ignores nuanced behavioral and emotional patterns. The lack of tight integration between a generative AI model, a simulation or optimization engine, and real-time emotion monitoring results in suboptimal allocation of computational resources and limits the ability of the system to make timely, data-driven adjustments. From a computer technology perspective, the system fails to exploit the available sensor data and learned models to automatically refine its internal representations, decision policies, and prompt generation logic.

Moreover, existing systems rarely support continuous, programmatic improvement of both the machine learning models and the prompt-generation module based on post-event evaluation. Without such a closed loop, the processor cannot systematically reduce prediction error, cannot automatically tune key parameters of its analytics and generative components, and cannot improve the end-to-end efficiency and effectiveness of the facility attraction pipeline.

Accordingly, there is a need for a computer-implemented system that (i) integrates attraction information, visitor attributes, and emotion states into structured context data suitable for machine consumption, (ii) automatically generates prompt sentences for a generative AI model based on that context, (iii) couples the generative AI outputs with simulation or optimization processes for staffing and event planning, and (iv) maintains a feedback mechanism that uses event outcomes to adapt model parameters and prompt-generation rules. Such a system would improve the functioning of the underlying computer technology by optimizing data flows, reducing manual configuration of prompts, and enabling the processor to autonomously refine its behavior over time.

The specific processing by the specific processing unit 290 of the data processing device 12 in Application Example 2 is realized by the following means.

The present invention provides a server comprising a processor and one or more memory devices storing instructions that, when executed by the processor, cause the processor to acquire facility-related attraction information from one or more detection devices and one or more storage devices; to perform preprocessing and statistical processing on the facility-related attraction information to extract attraction tendencies including numbers of visitors, dwell times, visit times, and transaction information; to acquire visitor attribute information from at least one image acquisition device and at least one identification detection device and to perform feature extraction and classification processing on the attribute information to generate attribute segments including age group, gender, and interest category; to acquire visitor expression information and audio information and apply an emotion estimation algorithm to the expression information and the audio information to determine an emotion state and an associated confidence value for each visitor; to associate and integrate the attraction tendencies, the attribute segments, and the emotion states and generate context data indicating visitor compositions and emotion distributions by time zone and by area; to extract, from the context data, text information describing a visit time zone, a target segment, a spending tendency, and an emotion distribution, and automatically generate a prompt sentence for input to a generative information processing model by applying a language processing algorithm to the text information; to input the prompt sentence into the generative information processing model, cause the generative information processing model to generate event plan information including event content or promotion content, and store the event plan information as structured data; to calculate staffing plans by time zone and by area by using the event plan information, the attraction tendencies, and the attribute segments while executing a simulation process or an optimization process; to notify a management terminal of the event plan information and the staffing plans, and update the event plan information and the staffing plans in response to an execution instruction or a modification instruction acquired from the management terminal; and to record, as evaluation indices, facility-related attraction information, attribute information, and emotion states acquired after execution of the event plan information, and update parameters of at least one machine learning algorithm and parameters of a prompt sentence generation process based on the evaluation indices. This enables integrated and automated generation of machine-optimized prompt sentences and event plans based on structured context data, improves the internal operation of the server by closing a feedback loop between sensor-driven analytics, generative AI output, and post-event evaluation, and enhances computational efficiency and effectiveness in generating and adapting event and staffing strategies within facility attraction systems.

The term “facility-related attraction information” refers to information indicating usage conditions of a facility, including at least visitor counts, visitor dwell times, visit times, transaction records, and other data obtained from one or more detection devices and one or more storage devices that represent how visitors are attracted to and behave within the facility.

The term “detection device” refers to any hardware component configured to sense or capture data related to visitors or the facility environment, including but not limited to cameras, motion sensors, radio frequency identification readers, wireless communication modules, and point-of-sale interfaces.

The term “storage device” refers to any hardware component or system that stores data in a non-transitory manner, including but not limited to databases, file systems, and external storage services accessible by the processor over a communication network.

The term “preprocessing” refers to operations applied to raw data to prepare the data for analysis, including at least validation, cleaning, normalization, transformation, and structure conversion of the raw data into a machine-readable format suitable for statistical processing and machine learning.

The term “statistical processing” refers to computations that derive summary values or patterns from data, including but not limited to aggregation, averaging, distribution analysis, correlation analysis, and time-series analysis.

The term “attraction tendencies” refers to patterns and characteristics derived from facility-related attraction information, including distributions and trends of visitor numbers, dwell times, visit times, transaction amounts, and other metrics that describe how visitors are drawn to and move within the facility.

The term “attribute information” refers to data describing characteristics of a visitor, including at least age group, gender, and interest category, and optionally including additional demographic or behavioral attributes.

The term “image acquisition device” refers to a hardware component configured to capture visual information, including but not limited to a camera, an imaging sensor, or an integrated imaging module in a portable terminal.

The term “identification detection device” refers to a hardware component configured to obtain identifying information regarding a visitor, including but not limited to a radio frequency identification reader, a card reader, or a wireless communication module that reads identifiers associated with visitors.

The term “feature extraction” refers to processing that transforms raw or low-level data into higher-level numerical or categorical representations, which capture significant characteristics of the data for use in classification, clustering, or other machine learning algorithms.

The term “classification processing” refers to operations that assign data instances to one or more categories or classes based on extracted features, using rule-based logic, statistical methods, or machine learning algorithms.

The term “attribute segments” refers to groups or clusters of visitors that share similar attribute information, such as age group, gender, or interest category, generated by applying feature extraction and classification processing to the attribute information.

The term “expression information” refers to visual data representing a visitor's facial expression or body posture obtained from an image acquisition device, which is used as input to an emotion estimation algorithm.

The term “audio information” refers to acoustic data representing a visitor's voice or ambient sound captured by a sound acquisition device, which is used as input to speech recognition or emotion estimation algorithms.

The term “emotion estimation algorithm” refers to a computational procedure, implemented by software or hardware, that processes expression information and audio information to infer an emotional state of a visitor and optionally a confidence value associated with the inference.

The term “emotion state” refers to a representation of a visitor's emotional condition, including but not limited to states such as joy, neutrality, surprise, dissatisfaction, or other affective categories determined by the emotion estimation algorithm.

The term “context data” refers to structured data that combines attraction tendencies, attribute segments, and emotion states, and that indicates compositions of visitors and emotion distributions for individual time zones and areas within the facility.

The term “language processing algorithm” refers to a computational method that operates on text data, including but not limited to natural language processing techniques for tokenization, parsing, template filling, text generation, and summarization.

The term “prompt sentence” refers to a text sequence generated by the language processing algorithm, which encodes context data and instructions and is designed for input to a generative information processing model in order to cause the model to generate event plan information.

The term “generative information processing model” refers to a trained computational model configured to generate new information, such as text or structured data, based on an input prompt sentence, including but not limited to a machine learning model that produces event content or promotion content.

The term “event plan information” refers to information generated by the generative information processing model, including but not limited to event content, promotion content, schedules, target segments, and other parameters related to planned events or campaigns in the facility.

The term “structured data” refers to data organized in a predefined format, such as records, fields, or key-value pairs, that allows programmatic access and processing by the processor and external applications.

The term “staffing plan” refers to information that specifies allocation of personnel resources over time and space, including at least recommended numbers of staff members by time zone and by area within the facility.

The term “simulation process” refers to a computational procedure that models facility operations, visitor flows, and staff activities to estimate performance metrics of different staffing or event-planning scenarios.

The term “optimization process” refers to a computational method that searches over candidate solutions, such as staffing configurations, to find one or more solutions that satisfy constraints and improve one or more objective metrics.

The term “management terminal” refers to an information processing device operated by facility personnel, including but not limited to a portable terminal, a workstation, or another user interface device used to receive notifications and provide instructions to the server.

The term “execution instruction” refers to an operation performed via the management terminal that indicates approval or initiation of at least part of the event plan information or staffing plan.

The term “modification instruction” refers to an operation performed via the management terminal that indicates a change request to at least part of the event plan information or staffing plan.

The term “evaluation indices” refers to metrics recorded after execution of the event plan information, including at least updated facility-related attraction information, updated attribute information, and updated emotion states, which are used to assess performance of events and to adjust model parameters.

The term “machine learning algorithm” refers to a computational method that learns patterns or relationships from data and updates internal parameters to perform tasks such as prediction, classification, clustering, or recommendation.

The term “prompt sentence generation process” refers to the sequence of operations implemented by the processor to derive text-based prompt sentences from context data, including extraction of relevant text information and application of the language processing algorithm.

In one embodiment, a facility-attraction system includes a server, one or more terminals, and multiple detection devices deployed in a commercial facility. The server includes at least one processor and at least one non-transitory memory. The terminals include portable information processing devices such as smartphones or tablets operated by users managing the facility. The detection devices include cameras, radio-frequency identification readers, point-of-sale interfaces, wireless communication modules, and environmental sensors.

Server executes computer programs stored in the memory to implement the functions described below. Server runs an operating system, such as a general-purpose server operating system, and application software implemented in a programming language such as Python.

Server uses software libraries including a numerical computation framework (for example, a tensor-based computation library), a machine learning library (for example, a library providing clustering and regression algorithms), a deep learning framework (for example, a framework capable of defining and training neural networks), a natural language processing library (for example, a library for tokenization and syntactic analysis), and a data visualization library (for example, a 2D plotting library).

Terminal acquires visitor-related data through a user interface and integrated sensors.

Terminal provides a check-in screen in which a visitor or a staff member can input attribute information such as age group, gender, and preference categories. Terminal also cooperates with a point-of-sale system to obtain transaction records including purchased item categories, amounts, and timestamps. Terminal measures approximate location of the visitor by using a wireless communication module that detects identifiers of access points or short-range beacons. Terminal captures images by using an integrated camera, and captures audio by using an integrated microphone with user consent.

Terminal transmits collected data to Server via a communication network such as a wireless local area network or a wide area network. Terminal formats the data as structured records, for example key-value pairs containing visitor identifiers, timestamps, location identifiers, attribute values, and references to media data. Terminal sends the data to an application programming interface endpoint exposed by Server. This configuration reduces manual data entry, ensures consistent data structure, and allows Server to process large volumes of data at high speed.

Server receives the structured records and stores them in one or more storage devices, such as relational databases and object storage. Server organizes facility-related attraction information into tables that represent raw events, such as check-in events, visit events, and transaction events. Server defines database schemas including identifiers, time fields, location fields, attribute fields, and emotion fields. Server stores paths or identifiers of media files, such as images and audio clips, in association with corresponding session identifiers.

Server performs preprocessing on the stored raw data to improve data quality and reduce computational load for subsequent processing. Server uses a data-processing library such as Pandas to read raw tables into memory as data frames. Server validates each record by checking required fields, type consistency, and range constraints. Server removes or flags inconsistent records, such as those with impossible age values or missing critical identifiers.

Server applies normalization to numerical fields, for example scaling dwell times and purchase amounts to a fixed range. Server encodes categorical fields, such as gender and interest category, into numerical feature vectors using techniques such as one-hot encoding. This preprocessing improves robustness of downstream machine learning models, reduces numerical instability, and increases processing speed by allowing vectorized operations.

Server executes statistical processing on the normalized data. Server aggregates visitor counts, dwell times, and transaction totals by time intervals and by spatial regions of the facility. Server computes measures such as averages, medians, variances, and quantiles.

Server also performs time-series analysis to detect periodic patterns, such as daily or weekly cycles of visitor traffic. By storing these statistical measures in separate tables, Server can respond to queries from Terminals quickly without recomputing heavy aggregations.

Server performs feature extraction and classification processing on attribute information.

Server applies a clustering algorithm, such as k-means clustering provided by a machine learning library, to the feature vectors representing age group, gender, preference categories, and purchase indicators. Server selects the number of clusters by evaluating metrics such as silhouette scores or information criteria. Server assigns a cluster label to each visitor session and interprets each cluster as an attribute segment, for example a “young fashion-oriented group” or a “family electronics-oriented group.” Server stores the segment label together with the original session record. Compared to rule-based segmentation manually created by human operators, this automatic segmentation adjusts dynamically to changing patterns and can process a large number of visitors in real time.

Server performs emotion estimation by processing expression information and audio information. Server uses a computer vision library, such as an image-processing library, to detect faces in images sent from Terminals. Server crops and resizes detected faces to a unified resolution and normalizes pixel values. Server then inputs these normalized images into a convolutional neural network (CNN) defined in a deep learning framework. In one embodiment, the CNN includes multiple convolutional layers with rectified linear unit activations, pooling layers, and fully connected layers that output probability scores for discrete emotion classes such as joy, neutrality, surprise, and dissatisfaction. Server trains the CNN in advance using labeled datasets. During training, Server defines a cross-entropy loss function between predicted probabilities and true labels, and Server performs weight updates by stochastic gradient descent or a variant such as Adam optimization. Server may apply data augmentation, such as random cropping, rotation, and brightness adjustment, to improve generalization and robustness to different lighting conditions.

Server also processes audio information for emotion estimation. Server uses a speech-recognition service or library to convert audio to text and simultaneously extracts acoustic features such as pitch contours, energy, and spectral coefficients. Server inputs these features into a recurrent neural network (RNN) or a temporal convolutional network that outputs emotion probabilities. Server combines the image-based and audio-based emotion predictions, for example by weighted averaging of probability distributions or by a meta-classifier that takes both modality outputs as input. Server stores the final emotion state and associated confidence value in an emotion table.

Server generates context data by associating attraction tendencies, attribute segments, and emotion states. Server joins the event tables, segment tables, and emotion tables by session identifier and time interval. Server constructs context records that include time slot, area, dominant segment, distribution of emotions, average transaction amounts, and forecasted visitor counts. Server stores context data in a dedicated table designed for efficient retrieval by time and area keys. This structured representation enables machine consumption of rich contextual information and avoids complex ad hoc database queries at the time of generating event plans.

Server generates prompt sentences for a generative AI model by applying a language processing algorithm to context data. Server retrieves a subset of context data for a target planning horizon, such as a specific day and time window, and analyzes the data using a natural language processing library. Server maps numerical ranges to textual descriptors, such as “high traffic,” “medium spending,” or “predominantly joyful visitors.” Server fills template structures that include fields for visit time, dominant segment, spending tendency, and emotion distribution. In one example, Server generates a prompt sentence such as: “Based on the following situation: ‘On Saturday from 14:00 to 17:00, most visitors are joyful women aged 18-25 who like fashion and music and have medium purchase amounts.’ Propose three detailed event concepts that can increase their enjoyment and average spending by 10%. Include event titles, required staff roles, schedule, and simple promotion plans.” In another example, Server generates a prompt sentence such as:
“Traffic is low on weekday mornings between 10:00 and 12:00. Propose three promotion ideas that will attract families with children to the facility, including discount types, activities for children, and approximate required staff.”

Server records prompt sentences together with identifiers of the underlying context data, so that Server can later correlate prompt structures with performance outcomes. This recording allows Server to improve prompt templates and selection logic over time, which is a technical improvement in the behavior of the generative pipeline.

Server inputs the generated prompt sentence into a generative AI model. The generative AI model is implemented as a neural language model that accepts text input and outputs text sequences representing event plan information. The model may have a transformer architecture comprising multiple attention layers, feed-forward layers, and normalization layers. During its offline training, the model is optimized by minimizing a language modeling loss function using large-scale textual corpora, including but not limited to descriptions of events, promotions, and operational plans. Server executes inference by sending the prompt sentence and optional configuration parameters such as maximum output length and temperature to an inference engine, either hosted locally or accessed via a network service. The model returns text that describes one or more event plans, including names, outlines, intended audience, material requirements, and recommended timing.

Server parses the generated text to extract structured attributes of each proposed event. Server uses pattern matching, simple parsing rules, or additional natural language processing components to identify event titles, time windows, target segments, and staff roles. Server stores the extracted information as event plan records. Server may reject or flag outputs that do not meet minimal structural requirements, such as missing time information, and may regenerate prompt sentences with adjusted constraints. This structured representation of generated content enables Server to use event plans as input to further computational processes, such as simulation and optimization, rather than merely displaying text content.

Server calculates staffing plans by applying simulation or optimization techniques to combined data of event plans, attraction tendencies, and attribute segments. Server models the facility as a set of zones with parameters such as expected arrival rates, service capacities, and walking times between zones. Server executes a discrete-event simulation engine or an agent-based simulation engine, such as one implemented by a simulation platform, to estimate queue lengths, waiting times, and staff utilization for various staffing configurations. In another embodiment, Server formulates a mathematical optimization problem where the objective is to minimize a cost function determined by the sum of staffing cost and a penalty for long waiting times, subject to constraints such as maximum allowed queue length and minimum number of staff per zone. Server uses an optimization algorithm such as linear programming, mixed-integer programming, or heuristic search to find near-optimal staffing plans.

Server notifies a management terminal of event plan information and staffing plans. Terminal receives notifications as structured messages via a push notification mechanism or via periodic polling. Terminal displays event names, recommended times, target segments, and required staff numbers in user interface screens. Terminal allows User to approve, reject, or modify suggested plans. User can adjust parameters such as event duration, location within the facility, or number of staff assigned. Terminal transmits these instructions back to Server.

Server updates stored event plan information and staffing plans based on these instructions.

Server maintains versioned records, where initial automatically generated proposals and modified, approved plans are both retained. This versioning enables comparison between original computational suggestions and actual implemented configurations. Such comparison data is later used as part of evaluation indices.

After events or promotions are executed, Terminal and detection devices continue to collect facility-related attraction information, including updated visitor counts, dwell times, and transaction metrics. Terminal may also request additional emotion estimation during events, capturing new images and audio. Server aggregates these post-execution data into event outcome records. Server computes evaluation indices such as realized uplift in visitor traffic, change in average transaction value, and change in distribution of emotion states.

Server analyzes correlations between prompt sentences, generated event plan structures, and evaluation indices. Server identifies which prompt patterns, context representations, and event attributes tend to produce higher performance. Server adjusts parameters of the prompt sentence generation process, such as template selection rules, threshold values for mapping numerical data to textual descriptors, and weighting of emotion features versus pure attribute features. Server also retrains or fine-tunes machine learning models, such as the clustering model for segments and forecasting models for traffic, using the new data. Server may update hyperparameters of these models, such as the number of clusters, learning rates, or regularization strengths, to reduce prediction error and computing cost. This closed-loop adaptation improves the inner workings of the server over time, resulting in faster convergence, more accurate forecasts, and more effective event generation.

This architecture yields specific technical effects. Because context data are precomputed and stored in a structured format, Server can generate prompt sentences and call the generative AI model without performing heavy joins and computations at query time, thereby reducing latency and processing load. Because statistical preprocessing and outlier handling are performed automatically by the program, Server reduces memory waste and avoids repeated processing of noisy data, improving overall throughput. The emotion estimation pipeline, having a well-defined neural network architecture and training procedure, produces emotion states with quantifiable confidence values, which allows Server to discard low-confidence estimates and thereby reduce the influence of noisy data on downstream decisions.

The combined use of machine-learned segments, emotion states, and time-based attraction tendencies provides input features that are not easily handled manually by human planners.

Server uses these features in non-conventional ways, for example by mapping them into prompt sentences with automatically adjusted wording and complexity depending on model performance history. This is not a mere automation of manual campaign design; instead, it is an improvement of how the server internally structures, processes, and reuses data for generative purposes.

In contrast to typical business-rule engines, Server does not rely on static if-then rules. Server uses learned models that dynamically adjust based on continuous feedback. The feedback loop where evaluation indices modify both machine learning model parameters and prompt-generation logic is a non-conventional computing mechanism that enhances accuracy and adaptability. This mechanism allows the server to change its internal computation pathways, for example by allocating more weight to emotion distributions when they have shown predictive value in evaluation indices, which reduces error in prediction of event performance.

In another embodiment, Server supports real-time adaptation. When Server detects abnormal emotion distributions or visitor fluctuations that meet predetermined criteria, Server immediately regenerates context data for the affected time and area and produces an additional prompt sentence tailored to the situation. For example, Server may generate: “In the fashion event area, dissatisfaction has increased among visitors in their twenties due to long queues. Propose immediate corrective actions, such as music change, extra staff, or quick discount, that can reduce dissatisfaction within 30 minutes.” Server sends this prompt sentence to the generative AI model and interprets the returned suggestions into concrete, structured actions. Server notifies Terminal with high-priority messages, allowing User to rapidly implement corrective measures. By automating this pathway with predefined thresholds and data structures, Server reduces reaction time compared to manual monitoring and manual decision-making, and optimizes technical use of network and processing resources by limiting high-frequency re-computation to situations where thresholds are exceeded.

In another embodiment, different types of detection devices and different neural network architectures can be used. Server may incorporate additional sensors, such as Bluetooth beacons for precise location tracking or depth cameras for crowd density estimation. Server may employ alternative deep learning models, such as graph neural networks to model interactions between visitors or attention-based time-series models to better capture seasonality. Server may also partition its processing pipeline into microservices, each responsible for preprocessing, clustering, emotion estimation, prompt generation, and event evaluation, allowing concurrent execution on multiple computing nodes to increase scalability and reduce processing time.

User interacts with the system primarily through Terminal. User reviews suggested event plans and staffing plans, provides approvals and modifications, and may initiate custom prompt sentences. For example, User may input:
“Using the latest visitor attribute data and emotion data, propose a small-scale event for families on Sunday afternoon with a low budget.”

Terminal transmits this prompt sentence to Server, which records it, sends it to the generative AI model, and processes the response in the same structured manner. This interface enables User to benefit from the system's internal data structures and learned models without needing to manually manage complex data flows or model parameters.

Through the described hardware and software configuration, the system improves computer technology by defining specific data structures, learned models, and processing flows that cause the server to manage and use high-volume, heterogeneous sensor data in an efficient, adaptive, and generative manner. The system reduces computational redundancy by centralizing preprocessing; reduces latency by maintaining context data; improves accuracy through learned segmentation and emotion estimation architectures; and enhances adaptability by using evaluation indices to update model and prompt-generation parameters. These effects go beyond mere automation of human planning tasks and constitute technical improvements in how computers process and utilize data to drive actions in a physical facility.

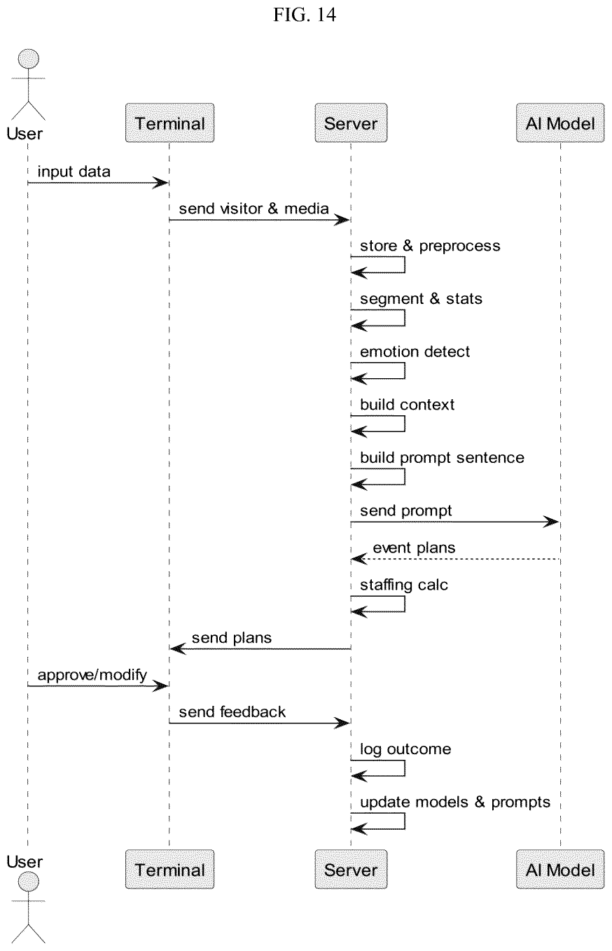

The following describes the processing flow using FIG. 14.

### Step 1:

Terminal acquires raw visitor data.

Terminal displays a check-in or interaction screen and prompts a visitor or staff member to input age group, gender, and preference categories (for example, fashion, electronics, food).

Input: manual inputs (age group, gender, preferences), device timestamp, location identifier, and, if available, membership identifier.

Terminal reads transaction information (item categories, amounts, timestamps) from a point-of-sale interface and obtains wireless identifiers from access points or beacons to estimate a zone identifier.

Terminal combines these values into a structured record, performs basic format validation (for example, ensuring fields are not empty and types are correct), and sends the record to Server through a network request.

Output: a structured visitor session record transmitted to Server.

### Step 2:

Terminal acquires media data for emotion analysis.

Terminal uses an integrated camera to capture one or more images of the visitor's face or a short video clip, and uses a microphone to record a short audio segment when the visitor speaks, subject to user consent.

Input: raw pixel data from the camera sensor and raw audio waveform from the microphone.

Terminal compresses image data (for example, encoding to JPEG) and audio data (for example, encoding to AAC or WAV), associates them with a session identifier and timestamp, and sends them as a media payload to Server via an upload API.

Output: compressed image and audio files with associated metadata transmitted to Server.

### Step 3:

Server stores and indexes raw data.

Server receives structured visitor session records and media payloads from Terminals.

Input: visitor session records and media payloads (compressed images and audio) received over the network.

Server writes session records into a database table dedicated to raw events and stores media files in an object storage system, recording file paths or object identifiers in a media metadata table linked to the corresponding session identifiers.

Server creates indexes on fields such as session identifier, timestamp, and zone identifier to accelerate later queries.

Output: persistent raw event records and media references stored and indexed in Server's storage.

### Step 4:

Server preprocesses attraction and attribute data.

Server periodically loads new raw event records from the database into memory as data frames using a data-processing library.

Input: raw event records containing age group, gender, preferences, dwell time estimates, transaction amounts, and timestamps.

Server validates each record (for example, checking that age group is within a defined set, and timestamps are valid), removes or flags invalid records, fills missing values by default rules or statistical imputation, scales numerical fields into normalized ranges, and encodes categorical fields into numerical vectors using one-hot encoding.

Server writes the cleaned and transformed records into a preprocessed events table separate from the raw events table.

Output: normalized and encoded event records ready for machine-learning analysis.

### Step 5:

Server segments visitors into attribute-based groups.

Server reads preprocessed event records containing normalized feature vectors.

Input: feature vectors representing age group, gender, preference categories, and purchase characteristics.

Server applies a clustering algorithm (for example, k-means) to group visitors into segments by minimizing within-cluster distances in feature space; Server iteratively updates cluster centroids until convergence.

Server assigns each visitor record a segment identifier corresponding to the nearest centroid and stores the mapping in a visitor segments table linked to each session identifier.

Output: segment labels for each visitor session and segment definitions stored in Server's database.

### Step 6:

Server computes attraction tendencies and time patterns.

Server aggregates preprocessed event data by time interval and facility zone.

Input: normalized event records with timestamps, zone identifiers, and transaction data.

Server groups records by time slots (for example, 30-minute or 1-hour bins) and zones, then computes counts of visitors, average dwell times, and total transaction amounts for each group using aggregation functions.

Server identifies peak and off-peak periods by comparing aggregated metrics to threshold values or percentiles and records these tendencies in time pattern tables.

Output: attraction tendencies per time slot and zone, including peak and off-peak classifications.

### Step 7:

Server performs emotion estimation from images and audio.

Server retrieves media references for sessions requiring emotion analysis and loads the corresponding images and audio files.

Input: compressed images and audio files linked to session identifiers.

Server uses an image-processing library to detect faces in each image, crops and resizes facial regions, and normalizes pixel intensities; then Server sends the processed images through a convolutional neural network to obtain emotion probability distributions.

Server uses a speech-processing tool to convert audio to text and extracts acoustic features such as pitch and energy; then Server processes these features with a temporal model to yield emotion probabilities from audio.

Server combines image-based and audio-based emotion probabilities (for example, by weighted averaging or rule-based selection) to determine a final emotion state and associated confidence for each session and records the result in an emotion records table.

Output: emotion states and confidence values associated with each visitor session.

### Step 8:

Server constructs integrated context data.

Server joins attraction tendencies, attribute segments, and emotion records along session identifiers, time slots, and zones.

Input: visitor segments table, time pattern tables, and emotion records table.

Server generates context records that include, for each time zone and facility area, the distribution of segments, distribution of emotion states, average transaction amounts, and predicted traffic levels.

Server stores these context records in a dedicated context table with keys on time slot and zone, enabling efficient retrieval for later planning.

Output: integrated context data entries representing combined behavioral, attribute, and emotion information.

### Step 9:

Server generates a prompt sentence for a generative AI model.

Server selects context records for a particular planning horizon (for example, a specific upcoming day and time window) and parses numerical metrics into human-readable descriptors.

Input: context records containing segment distributions, emotion distributions, and spending tendencies.

Server applies a language processing algorithm to convert key fields (such as dominant segment, predominant emotion, and spending level) into descriptive phrases and fills them into prompt templates that describe the current situation and planning goal.

For example, Server may generate the prompt sentence:
“Based on the following situation: ‘On Saturday from 14:00 to 17:00, most visitors are joyful women aged 18-25 who like fashion and music and have medium purchase amounts.’

Propose three detailed event concepts that can increase their enjoyment and average spending by 10%. Include event titles, required staff roles, schedule, and simple promotion plans.” Output: a prompt sentence in natural language that encodes the selected context and planning objectives.

### Step 10:

Server invokes the generative AI model to obtain event plan information.

Server sends the prompt sentence to a generative AI model through an inference interface or a network API.

Input: prompt sentence describing the facility context and requested output structure.

Server receives generated text describing event plans, including one or more event names, targeted segments, recommended times, and resource requirements.

Server parses the generated text using pattern recognition and natural language parsing to extract structured fields such as event title, start time, end time, location, and required staff roles, then stores these in an event plans table.

Output: structured event plan information linked to the original prompt and context.

### Step 11:

Server computes staffing plans via simulation or optimization.

Server reads event plan records for the relevant time horizon and combines them with forecasted traffic, attraction tendencies, and segment distributions.

Input: event plans, time pattern data, and segment distributions.

Server inputs these data into a simulation engine or an optimization module that models visitor arrivals and service processes; Server explores candidate staffing configurations by varying staff counts per zone and per time slot, computes performance metrics such as waiting time and utilization, and searches for configurations that satisfy constraints and minimize a cost function.

Server writes the selected configuration as a staffing plan, containing recommended number of staff and their assignment by zone and time slot, into a staffing plans table.

Output: optimized staffing plans with associated performance metrics.

### Step 12:

Server delivers recommendations to management terminals and receives feedback.

Server composes notification messages that summarize event plans and staffing plans, including key metrics and expected effects.

Input: structured event plan information and staffing plans from the database.

Server sends these messages to Terminals used by managers through a messaging or push-notification service.

Terminal receives the notifications, displays event descriptions, times, and staffing recommendations, and provides options for User to approve, adjust, or reject each plan.

User reviews the information, selects options (such as “approve event,” “change time,” or “reduce staff by one person”), and submits decisions via Terminal.

Output: manager decisions and modifications transmitted back to Server.

### Step 13:

Server updates plans based on manager input.

Server receives manager decisions and adjustment parameters from Terminals.

Input: approval statuses, modified event details, and modified staffing levels.

Server updates corresponding entries in the event plans and staffing plans tables, marking approved plans as active and incorporating parameter changes such as new times or adjusted staffing counts.

Server logs both original and modified plans to enable later performance comparison.

Output: finalized event and staffing plans stored as active configurations.

### Step 14:

Server collects post-execution data and computes evaluation indices.

Server monitors detection devices and Terminals during and after the execution of events to gather updated attraction information, transaction data, and emotion states.

Input: post-execution raw event records, updated emotion records, and possibly additional terminal inputs.

Server aggregates these data by event and time period to compute evaluation indices such as actual visitor uplift, change in average transaction amount, and change in emotion distributions compared to baseline.

Server stores evaluation indices in an outcomes table associated with the prompts, event plans, and staffing plans used for each period.

Output: evaluation indices describing realized performance of executed plans.

### Step 15:

Server refines models and prompt-generation logic based on evaluation.

Server reads evaluation indices together with associated prompt sentences and plan structures.

Input: outcomes table entries, prompt sentence logs, and stored model parameters.

Server analyzes correlations between prompt forms, context features, and achieved performance using statistical analysis or secondary machine-learning models; based on this analysis, Server adjusts clustering parameters, forecasting model hyperparameters, and weights in emotion-combination rules, and updates thresholds or selection rules for prompt templates.

Server updates stored parameters of the machine-learning models and prompt-generation module so that future runs use improved configurations, thereby reducing prediction error and improving the relevance of generated event plans and staffing plans.

Output: updated model parameters and prompt-generation rules that influence subsequent processing cycles.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

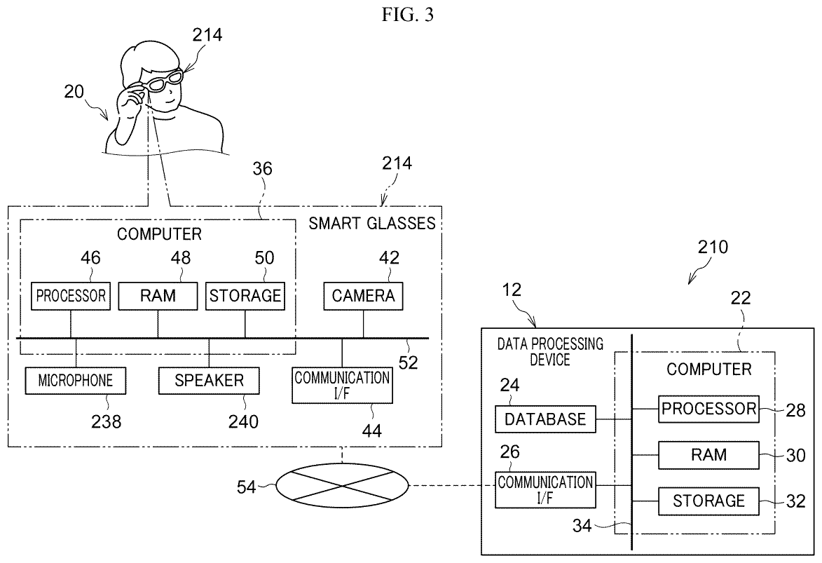

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

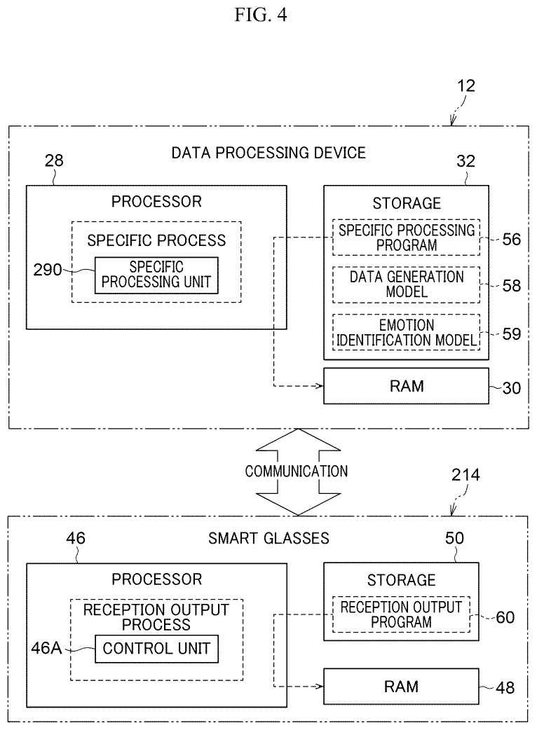

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

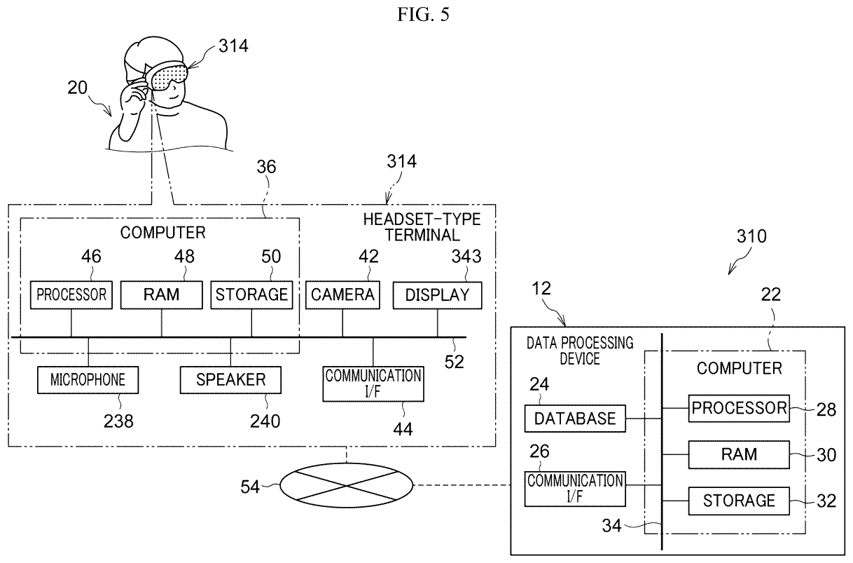

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

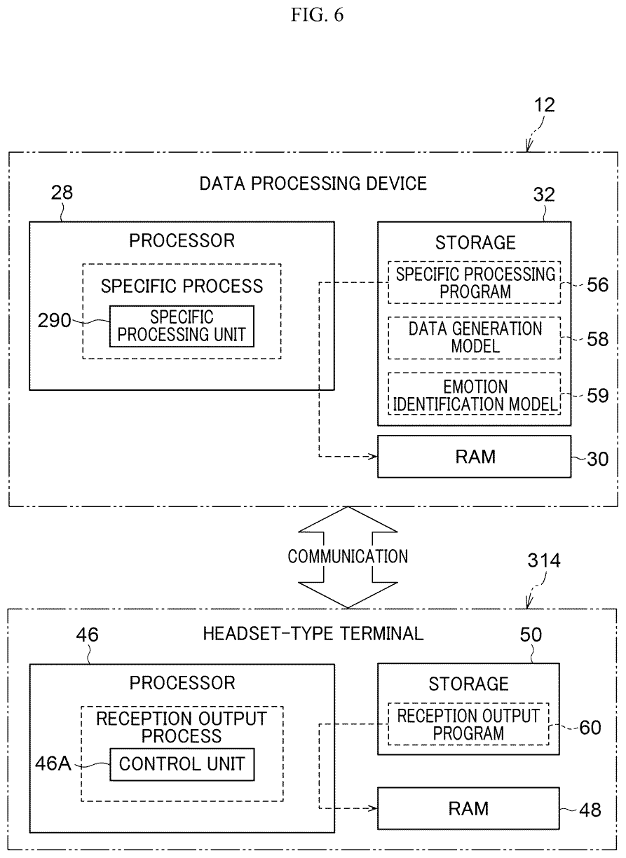

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

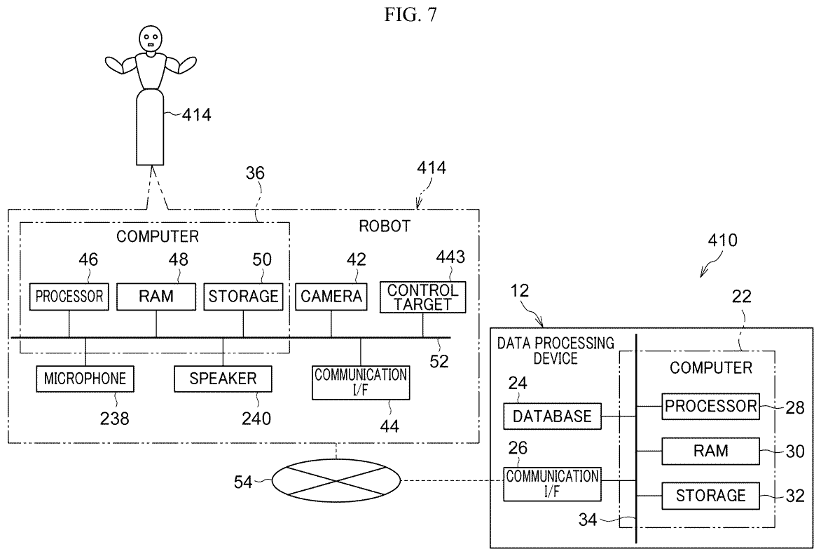

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

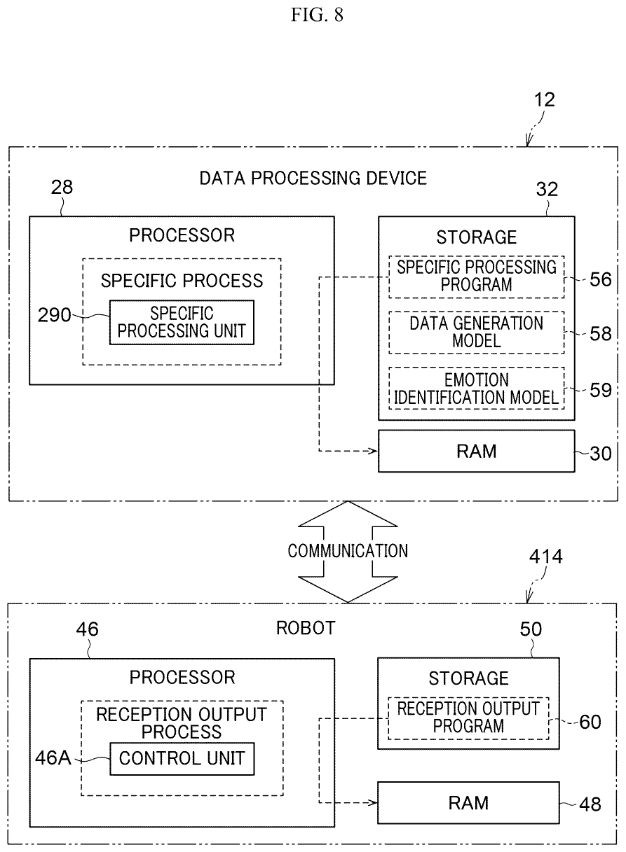

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

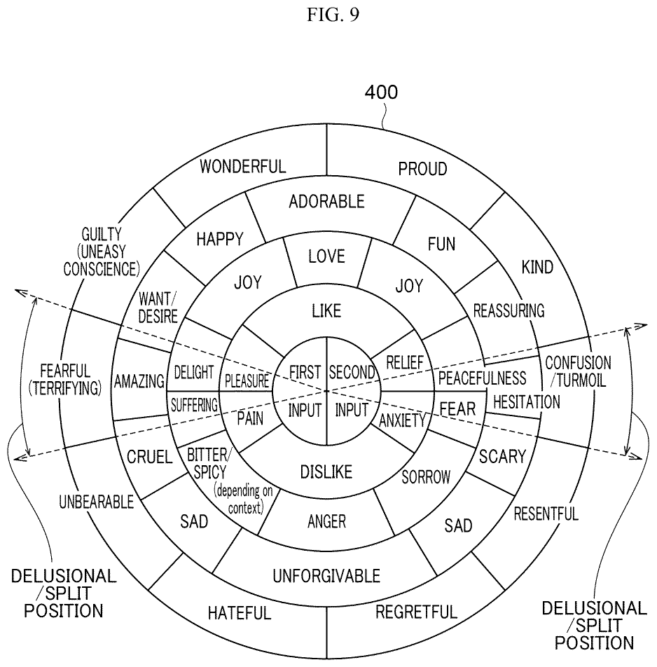

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

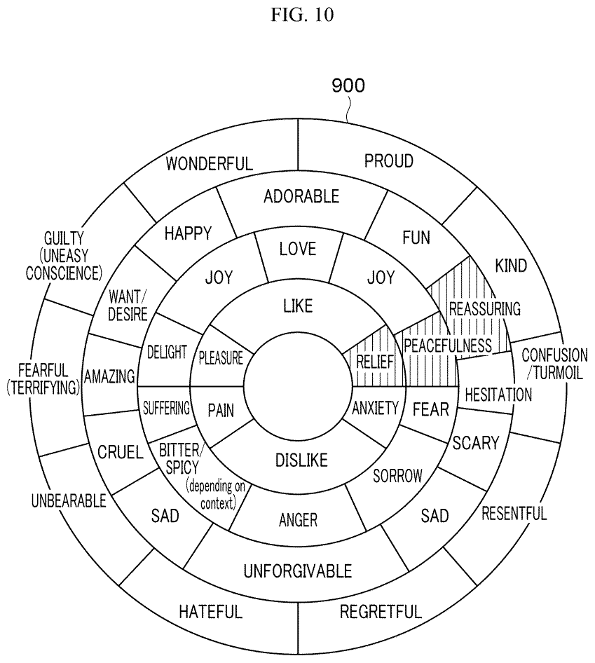

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire visit information in a facility from detection devices and information storage devices, and integrate a plurality of types of visit information including a number of visitors, visit times, visitor attributes, and behavior histories, and store the integrated information as visit session information, and
perform preprocessing on the visit session information on an information processing device, the preprocessing including missing-value completion, normalization, attribute encoding, and feature extraction of time information, and generate analysis feature data, and
execute a learning-model process on the analysis feature data, the learning-model process including classification processing, clustering processing, and time-series prediction processing, and obtain segment information of visitor groups, peak-time information of visitor attraction, and event-participation probability information, and
generate event-plan information and allocation-plan information based on the segment information and the peak-time information, the event-plan information including an event type, a target visitor group, a holding time period, a required number of workers, and required worker roles, and the allocation-plan information including a worker allocation plan corresponding to predicted demand, and
extract context information from the event-plan information and the allocation-plan information as a part of an input sentence for language generation, combine the context information with a request sentence in natural language that a user has input from a terminal, and generate a prompt sentence to be input to a generative AI model, and
transmit the prompt sentence to the generative AI model, and acquire, from the generative AI model, generated-result information including event contents, execution procedures, notification texts, and worker allocation proposals, and
update the event-plan information and the allocation-plan information based on the generated-result information, and store and output the updated information as an updated event plan and an updated worker allocation plan.

### (Supplementary 2)

The system according to supplementary 1,
wherein the processor is configured to
generate structured context information including summary information extracted from the visit session information and the analysis feature data, and automatically generate the prompt sentence by appending the structured context information to the request sentence in natural language that the user has input.

### (Supplementary 3)

The system according to supplementary 1,
wherein the processor is configured to
execute an optimization process that determines the worker allocation included in the allocation-plan information by using the peak-time information and the event-participation probability information as inputs and, under constraint conditions concerning a number of workers and working hours, minimizing cost while satisfying a service level.

### Application Example 1

### (Supplementary 1)

A system comprising a processor,
wherein the processor is configured to
acquire user data via a communication network and store the user data including time-series information and attribute information in a storage,
perform preprocessing on the stored user data, the preprocessing including data structure conversion and missing-value processing, and calculate, by aggregation processing and feature generation processing, attraction indices by time period and by attribute, execute, on the basis of the attraction indices and the preprocessed user data, machine learning processing including clustering processing and prediction processing to extract user groups indicating visit tendencies and event participation tendencies, and to calculate a predicted number of visits for each time period and a predicted participation probability, generate, on the basis of the extracted user groups and the predicted number of visits, event candidate information including an event type candidate, a target user group, a scheduled time period, and a predicted number of participants, and calculate, on the basis of the predicted number of participants and a pre-stored staffing rule, a required number of personnel for each event,
generate, on the basis of the event candidate information and the required number of personnel, a prompt sentence in a natural language including an event objective, a target user group, a scheduled time period, and constraint conditions,
input the prompt sentence to a generative information processing model and store, in association with the event candidate information, an event content proposal and an advertising text acquired from the generative information processing model,
generate proposal information including the event candidate information, the required number of personnel, and the content acquired from the generative information processing model as display data, and transmit the display data to an external terminal device, and store, in association with the proposal information, approval information or modification information for the proposal information acquired from the external terminal device, and update at least part of the machine learning processing and prompt sentence generation processing on the basis of a result of the storing.

### (Supplementary 2)

The system according to supplementary 1,
wherein the processor is configured to
in acquiring the user data, store participation result information or sales result information input from the external terminal device in association with the time-series information and the attribute information, and perform retraining of the prediction processing by using the participation result information or the sales result information as teacher data.

### (Supplementary 3)

The system according to supplementary 1,
wherein the processor is configured to
in generating the prompt sentence, select or modify different templates for each of an event type, a target user group, and a scheduled time period on the basis of the approval information or the modification information for past proposal information, and dynamically generate the prompt sentence in the natural language by using the templates.

### Example 2

### (Supplementary 1)

A system comprising a processor,
wherein the processor is configured to
acquire facility-related information from detection devices and storage devices, store the information as raw data including identification information related to visitors, information related to purchases, and information related to stays in association with time information and area information, and accumulate the raw data, and
perform preprocessing on the raw data by complementing information related to missing values, removing information related to abnormal values, and performing encoding of classification attributes and normalization of numerical attributes so as to generate behavior-related feature values, and store the behavior-related feature values as preprocessed data, and execute, on the basis of the preprocessed data, a classification process and a time-related estimation process using a machine learning model so as to generate an analysis result including segments related to visitor behavior and temporal tendencies related to customer attraction, and
aggregate the analysis result into a structured internal representation, generate, on the basis of the internal representation, a prompt sentence in natural language including a target visitor segment, information related to a time period, and an operational objective, and input the prompt sentence to a generative AI model so as to obtain event-related content and operation-related proposals, and
analyze the event-related content and the operation-related proposals obtained from the generative AI model, store each proposal in association with a corresponding visitor segment and time period, and present the proposals to a user via a display device, and
estimate, on the basis of the analysis result and the event-related content, required personnel numbers for each time period and each area, generate a personnel allocation plan by using an optimization algorithm, and present the personnel allocation plan to the user, and
acquire, from a terminal device used by the user, correction information or evaluation information related to the event-related content and the personnel allocation plan, store the correction information or the evaluation information in association with the raw data or the preprocessed data, and reflect the correction information or the evaluation information in a subsequent analysis result and in subsequent generation of the prompt sentence.

### (Supplementary 2)

The system according to supplementary 1,
wherein the processor is configured to include, in the generation of the prompt sentence, a
visitor segment included in the analysis result, an index related to customer attraction for each time period, and classification information related to items, thereby obtaining, from the generative AI model, event-related content and operation-related proposals that are different for each visitor segment and each time period.

### (Supplementary 3)

The system according to supplementary 1,
wherein the processor is configured to, in generating the personnel allocation plan, calculate, on the basis of numbers of visitors and amounts of transactions for each time period included in the analysis result and role-related requirement information included in the event-related content, numbers of required personnel by role for each time segment and each area, and execute an optimization process on the basis of the numbers of required personnel by role and constraint information related to available personnel.

### Application Example 2

### (Supplementary 1)

A system comprising a processor,
wherein the processor is configured to
acquire facility-related attraction information from a detection device and a storage device, perform preprocessing and statistical processing on the facility-related attraction information, and extract attraction tendencies including numbers of visitors, dwell times, visit times, and transaction information,
acquire attribute information of visitors from an image acquisition device and an identification detection device, perform feature extraction and classification processing on the attribute information, and generate attribute segments including age group, gender, and interest category,
acquire expression information and audio information of the visitors, apply an emotion estimation algorithm to the expression information and the audio information, and determine an emotion state and a confidence value for each visitor,
associate and integrate the attraction tendencies, the attribute segments, and the emotion states, and generate context data indicating compositions of visitors and emotion distributions by time zone and by area,
extract text information describing visit time zone, target segment, spending tendency, and emotion distribution based on the context data, and automatically generate a prompt sentence for input to a generative information processing model by using a language processing algorithm and the text information,
input the prompt sentence into the generative information processing model, cause the generative information processing model to generate event plan information including event content or promotion content, and store the event plan information as structured data, calculate staffing plans by time zone and by area by using the event plan information, the attraction tendencies, and the attribute segments, and by executing a simulation process or an optimization process,
notify a management terminal of the event plan information and the staffing plans, and update the event plan information and the staffing plans in response to an execution instruction or a modification instruction acquired from the management terminal, and record, as evaluation indices, facility-related attraction information, attribute information, and emotion states acquired after execution of the event plan information, and update parameters of a machine learning algorithm and parameters of a prompt sentence generation process based on the evaluation indices.

### (Supplementary 2)

The system according to supplementary 1,
wherein the processor is configured to
analyze a correspondence between contents of the prompt sentence and the evaluation indices, and automatically improve the prompt sentence generated thereafter by adjusting template selection rules and extraction conditions of the context data based on characteristics of prompt sentences associated with event plan information having high performance.

### (Supplementary 3)

The system according to supplementary 1,
wherein the processor is configured to
monitor the emotion states and the attraction tendencies in real time, detect an abnormal emotion distribution or a fluctuation in a number of visitors that satisfies a predetermined condition, generate an additional prompt sentence by using the context data in response to the detection, input the additional prompt sentence into the generative information processing model to generate additional event plan information including corrective measures, and immediately notify the additional event plan information to the management terminal.

What is claimed is:

1. A system comprising:
circuitry configured to:
receive, via a communication interface coupled to a packet-switched network, sensor data from detection devices, the sensor data comprising visit count data, visit time data, attribute data, and behavior history records;
integrate the sensor data as visit session information, and perform preprocessing comprising at least missing-value completion, normalization, attribute encoding, and time-domain feature extraction to generate analysis feature data;
execute a machine learning model process on the analysis feature data, the machine learning model process comprising classification processing, clustering processing, and time-series prediction processing, to generate segment information of visitor groups, peak-time information, and event-participation probability information;
generate plan information based on the segment information and the peak-time information, the plan information comprising event type data, target segment data, a holding time period, and a resource allocation plan;
extract context information from the plan information, combine the context information with a request sentence received from a terminal device, generate a prompt sentence for a generative neural network model, transmit the prompt sentence to the generative neural network model, and receive generated-result information comprising event content data, execution procedure data, and notification text data; and
update the plan information based on the generated-result information, and transmit the updated plan information to the terminal device via the communication interface.

2. The system according to claim 1, wherein the circuitry is configured to acquire the sensor data from a plurality of detection devices distributed within a facility, and integrate the sensor data into the visit session information by associating records from each detection device with corresponding visitor identifiers and timestamps.

3. The system according to claim 2, wherein the circuitry is configured to perform the attribute encoding by converting categorical attribute fields into numeric vector representations, and apply normalization to standardize numeric feature values prior to input to the machine learning model process.

4. The system according to claim 3, wherein the circuitry is configured to execute the clustering processing to segment visitor groups into clusters based on attribute similarity, and assign each cluster a segment label for use in generating the target segment data.

5. The system according to claim 4, wherein the circuitry is configured to execute the time-series prediction processing to predict peak-time intervals by fitting a time-domain model to visit count data, and generate the peak-time information as predicted time intervals with associated visit density estimates.

6. The system according to claim 5, wherein the circuitry is configured to generate the event-participation probability information by applying the classification processing to classify visitor groups by predicted likelihood of participation in an event type based on the segment information and the peak-time information.

7. The system according to claim 1, wherein the circuitry is configured to generate the prompt sentence by embedding the context information, the segment information, and the peak-time information into a natural language template along with the request sentence, to cause the generative neural network model to generate event content data specific to the identified target segment.

8. The system according to claim 7, wherein the circuitry is configured to update the prompt sentence with revised plan information when the updated plan information differs from prior plan information by a deviation exceeding a recalculation threshold.

9. The system according to claim 1, wherein the circuitry is configured to store the visit session information, the analysis feature data, and the generated-result information as record information in a storage device, and update model parameters of the machine learning model process based on new visit session information.

10. The system according to claim 9, wherein the circuitry is configured to perform incremental learning on the machine learning model using newly accumulated visit session information to update the segment information and the peak-time information in response to changing visitor patterns.

11. The system according to claim 1, wherein the circuitry is configured to extract, from the generated-result information, notification text data, and transmit the notification text data to the terminal device in a formatted output for display or distribution.

12. The system according to claim 11, wherein the circuitry is configured to personalize the notification text data by including target segment data in the prompt sentence to cause the generative neural network model to generate segment-specific notification text.

13. The system according to claim 1, wherein the circuitry is configured to generate the resource allocation plan based on a required resource count derived from the event-participation probability information and the peak-time information.

14. The system according to claim 13, wherein the circuitry is configured to dynamically update the resource allocation plan based on updated event-participation probability information received from the machine learning model process.

15. The system according to claim 1, wherein the circuitry is configured to perform the missing-value completion by applying at least one of mean imputation and model-based imputation to fields in the visit session information having missing values.

16. The system according to claim 1, wherein the circuitry is configured to receive a natural language request sentence from the terminal device, extract intent information from the request sentence using a natural language processing model, and incorporate the intent information as an additional constraint in the prompt sentence.

17. The system according to claim 16, wherein the circuitry is configured to store the prompt sentence and the generated-result information as log information, and update generation conditions for subsequent prompt sentences based on the stored log information.

18. A system comprising:
circuitry configured to:
receive, via a communication interface coupled to a packet-switched network, sensor data from detection devices comprising visit count data, attribute data, and behavior history records;
integrate the sensor data as visit session information, and perform preprocessing comprising missing-value completion, normalization, attribute encoding, and time-domain feature extraction to generate analysis feature data;
execute classification processing, clustering processing, and time-series prediction processing on the analysis feature data to generate segment information of visitor groups, peak-time information, and event-participation probability information;
generate plan information comprising event type data, target segment data, a holding time period, and a resource allocation plan based on the segment information and the peak-time information;
construct a prompt sentence by embedding context information from the plan information and a natural language request sentence from a terminal device, execute inference processing using a generative neural network model with the prompt sentence as input to obtain generated-result information comprising event content data and notification text data; and
update the plan information based on the generated-result information and transmit the updated plan information to the terminal device via the communication interface.

19. The system according to claim 18, wherein the circuitry is configured to perform incremental learning on the machine learning model using newly accumulated visit session information to update model parameters and adapt the segment information to changing visitor patterns.

20. A method comprising:
receiving, via a communication interface coupled to a packet-switched network, sensor data from detection devices, the sensor data comprising visit count data, visit time data, attribute data, and behavior history records;
integrating the sensor data as visit session information, and performing preprocessing comprising at least missing-value completion, normalization, attribute encoding, and time-domain feature extraction to generate analysis feature data;
executing a machine learning model process on the analysis feature data, the machine learning model process comprising classification processing, clustering processing, and time-series prediction processing, to generate segment information of visitor groups, peak-time information, and event-participation probability information;
generating plan information based on the segment information and the peak-time information, the plan information comprising event type data, target segment data, a holding time period, and a resource allocation plan;
extracting context information from the plan information, combining the context information with a request sentence received from a terminal device, generating a prompt sentence for a generative neural network model, transmitting the prompt sentence to the generative neural network model, and receiving generated-result information comprising event content data, execution procedure data, and notification text data; and
updating the plan information based on the generated-result information, and transmitting the updated plan information to the terminal device via the communication interface.
